(19) United States
(12) Patent Application Publication
(10) Pub. No.: US 2026/0217123 A1
(43) Pub. Date: Jul. 30, 2026

(54) SYSTEM AND METHOD FOR IDENTIFYING USERS AND CREATING CUSTOM ADVERTISEMENT BLOCKS

(71) Applicant: ShareSafe Media, LLC, Mobile, AL (US)

(72) Inventor: Robert Hanson, II, Mobile, AL (US)

(73) Assignee: ShareSafe Media, LLC, Mobile, AL (US)

(21) Appl. No.: 19/158,245

(22) PCT Filed: Jan. 22, 2024
(86) PCT No.: PCT/US2024/012473

§ 371 Date: Aug. 20, 2025

Related U.S. Application Data
(63) Continuation of application No. 18/207,566, filed on Jun. 8, 2023.
(60) Provisional application No. 63/440,336, filed on Jan. 20, 2023.

(51) Int. Cl. B60K 35/81; B60K 35/10; B60K 35/28; B60K 35/65; B60K 35/80; B60K 35/85; G06Q 30/0251

(52) U.S. Cl. CPC B60K 35/81; G06Q 30/0265; B60K 35/10; B60K 35/28; B60K 35/65; B60K 35/80; B60K 35/85; B60K 2360/11; B60K 2360/122; B60K 2360/16; B60K 2360/573; B60K 2360/589; B60K 2360/741

(57) ABSTRACT

A system and method for preventing unauthorized access to subscription-based applications and creating custom advertisement blocks for said users is provided. A user may activate a display device, which may then identify the user via a security means, such as logging into a user profile via a computing device operably connected to the display device, scanning a predefined pattern, and/or a secondary security device. A computer readable signal containing login credentials may be sent to the display device, allowing the user to access various applications thereon. The system may create custom advertisement blocks for the user based on user data collected by the system. Where multiple users are present, multiple users may be able to access applications on a single display device based on said users'login credentials. In some embodiments, machine-based learning may be used to create custom advertisement blocks based on the users detected by the system.

### CROSS REFERENCES

This application claims priority to U.S. Provisional Application Ser. No. 63/440336, filed on Jan. 20, 2023, and U.S. Nonprovisional application Ser. No. 18/207,566, filed on Jun. 8, 2023, in which application is incorporated herein in its entirety by reference.

### FIELD OF THE DISCLOSURE

The subject matter of the present disclosure refers generally to a system and method for identifying users, securely logging into user applications based on the identity of said user, and creating custom advertisement blocks based on user data.

### BACKGROUND

It is difficult to accurately estimate the financial loss that streaming services have incurred due to account sharing, but some estimates put the loss at approximately $25 billion dollars a year. Although account sharing is a common practice among users of streaming services, companies have attempted to implement various measures to try to mitigate the impact of this on their revenue. For instance, some streaming services have implemented stricter account sharing policies that may result in suspension of a user's account, while others have increased prices but introduced features that allow users to share their accounts with a limited number of people. Further, the recommendation algorithms many streaming services employ are based on each user's individual viewing history. When multiple users share an account, their viewing histories become intertwined, which can result in the recommendations becoming less relevant to each user. This can make it more difficult for users to discover new content that they might enjoy.

Issues with account sharing by users can also make targeted advertising more difficult. Targeted advertising is a form of advertising that aims to deliver marketing messages to specific individuals or groups of consumers based on certain characteristics, such as demographics, interests, behaviors, or location. The goal of targeted advertising is to reach the right audience with the right message at the right time and place, in order to increase the effectiveness and efficiency of marketing campaigns. But when viewing histories and interests become intertwined due to account sharing, data pertaining to certain individuals provided by data brokers might be considered unreliable at best, which will cause a targeted advertisement campaign using this unreliable data to be less successful that it otherwise might be. And there currently isn't an easy solution for ensuring that the data pertaining to certain individuals is reliable.

Accordingly, there is a need in the art for a system and method that reduces account sharing between people and increases the reliability of data obtained by streaming services and data brokers.

### SUMMARY

A system and method for creating programmatic advertising and controlling displays within a homeplace or within a vehicle via a mobile computing device is provided. In one aspect, the system allows a user to customize content presented on a display within a homeplace or within a vehicle. In another aspect, the system identifies the location of users within a homeplace or within the vehicle to determine which display to present content or advertising. In yet another aspect, the system uses user data to create custom advertisement blocks for users within a homeplace or within a vehicle. Generally, the system and methods of the present disclosure are designed to allow users to control content presented on the various displays within a homeplace or within a vehicle. The system generally comprises a computing device having a user interface, display having a display user interface and operably connected to said processor, and non-transitory computer-readable medium coupled to said processor and having instructions stored thereon. Some preferred embodiments may also comprise a camera that collects image data that the system may use to identify users of the system. In another preferred embodiment, the system may comprise a locator node that may assist with determining the location of users within a vehicle. To prevent unauthorized access to the system, secondary security devices and permissions levels may be used.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other systems for carrying out the same purpose of the system and method disclosed herein. Those skilled in the pertinent art should also realize that such equivalent designs or modifications do not depart from the scope of the system and method of the present disclosure.

### DESCRIPTION OF THE DRAWINGS

These and other features, aspects, and advantages of the present disclosure will become better understood with regard to the following description, appended claims, and accompanying drawings where:

FIG. 1 illustrates a system embodying features consistent with the principles of the present disclosure.

FIG. 2 illustrates a system embodying features consistent with the principles of the present disclosure.

FIG. 3 illustrates a system embodying features consistent with the principles of the present disclosure.

FIG. 4 illustrates a system embodying features consistent with the principles of the present disclosure.

FIG. 5 illustrates a user interface of a computing device consistent with the principles of the present disclosure.

FIG. 6 illustrates a display user interface of a display consistent with the principles of the present disclosure.

FIG. 7 illustrates an environmental view of a display within the homeplace of a user comprising a plurality of display windows.

FIG. 8 illustrates an environmental view of a display within the homeplace of a first user and a second user comprising a plurality of display windows.

FIG. 9 illustrates an environmental view of a charging/fueling station having a display that may operably connect to a computing device of a user.

FIG. 10 illustrates an environmental view of a charging/fueling station having a display that may operably connect to a computing device of a user.

FIG. 11 illustrates an environmental view of a display within an airplane comprising a plurality of display windows.

FIG. 12 illustrates an environmental view of an interior space of an electric or internal combustion engine car, wherein a user is using their computing device to scan a predefined pattern of a display.

FIG. 13 illustrates an environmental view of a display within an electric or internal combustion engine car comprising a plurality of display windows.

FIG. 14 illustrates an environmental view of a display within an electric or internal combustion engine car and comprising a plurality of display windows.

FIG. 15 illustrates an environmental view of an interior space of an electric or internal combustion engine car comprising and a user controlling various components and vehicle features of the electric or internal combustion engine car via a computing device.

FIG. 16 illustrates the manner in which individual access to data may be granted or limited based on user roles and administrator roles.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For instance, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises”, and grammatical equivalents thereof are used herein to mean that other components, steps, etc. are optionally present. For instance, a system “comprising” components A, B, and C can contain only components A, B, and C, or can contain not only components A, B, and C, but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). As will be evident from the disclosure provided below, the present invention satisfies the need for a system and method capable of seamlessly integrating controls into a video feed which allows the user to choose two or more media sources to combine.

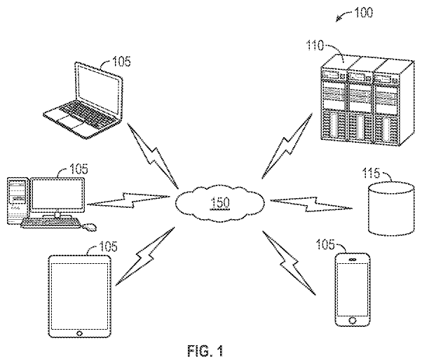

FIG. 1 depicts an exemplary environment 100 of the system 400 consisting of clients 105 connected to a server 110 and/or database 115 via a network 150. Clients 105 are devices of users 405 that may be used to access servers 110 and/or databases 115 through a network 150. A network 150 may comprise of one or more networks of any kind, including, but not limited to, a local area network (LAN), a wide area network (WAN), metropolitan area networks (MAN), a telephone network, such as the Public Switched Telephone Network (PSTN), an intranet, the Internet, a memory device, another type of network, or a combination of networks. In a preferred embodiment, computing entities 200 may act as clients 105 for a user 405. For instance, a client 105 may include a personal computer, a wireless telephone, a streaming device, a “smart” television, a personal digital assistant (PDA), a laptop, a smart phone, a tablet computer, or another type of computation or communication interface 280. Servers 110 may include devices that access, fetch, aggregate, process, search, provide, and/or maintain documents. Although FIG. 1 depicts a preferred embodiment of an environment 100 for the system 400, in other implementations, the environment 100 may contain fewer components, different components, differently arranged components, and/or additional components than those depicted in FIG. 1. Alternatively, or additionally, one or more components of the environment 100 may perform one or more other tasks described as being performed by one or more other components of the environment 100.

As depicted in FIG. 1, one embodiment of the system 400 may comprise a server 110. Although shown as a single server 110 in FIG. 1, a server 110 may, in some implementations, be implemented as multiple devices interlinked together via the network 150, wherein the devices may be distributed over a large geographic area and performing different functions or similar functions. For instance, two or more servers 110 may be implemented to work as a single server 110 performing the same tasks. Alternatively, one server 110 may perform the functions of multiple servers 110. For instance, a single server 110 may perform the tasks of a web server and an indexing server 110. Additionally, it is understood that multiple servers 110 may be used to operably connect the processor 220 to the database 115 and/or other content repositories. The processor 220 may be operably connected to the server 110 via wired or wireless connection. Types of servers 110 that may be used by the system 400 include, but are not limited to, search servers, document indexing servers, and web servers, or any combination thereof.

Search servers may include one or more computing entities 200 designed to implement a search engine, such as a documents/records search engine, general webpage search engine, etc. Search servers may, for instance, include one or more web servers designed to receive search queries and/or inputs from users 405, search one or more databases 115 in response to the search queries and/or inputs, and provide documents or information, relevant to the search queries and/or inputs, to users 405. In some implementations, search servers may include a web search server that may provide webpages to users 405, wherein a provided webpage may include a reference to a web server at which the desired information and/or links are located. The references to the web server at which the desired information is located may be included in a frame and/or text box, or as a link to the desired information/document. Document indexing servers may include one or more devices designed to index documents available through networks 150. Document indexing servers may access other servers 110, such as web servers that host content, to index the content. In some implementations, document indexing servers may index documents/records stored by other servers 110 connected to the network 150. Document indexing servers may, for instance, store and index content, information, and documents relating to user accounts and user-generated content. Web servers may include servers 110 that provide webpages to clients 105. For instance, the webpages may be HTML-based webpages. A web server may host one or more websites. As used herein, a website may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

As used herein, a database 115 refers to a set of related data and the way it is organized. Access to this data is usually provided by a database management system (DBMS) consisting of an integrated set of computer software that allows users 405 to interact with one or more databases 115 and provides access to all of the data contained in the database 115. The DBMS provides various functions that allow entry, storage and retrieval of large quantities of information and provides ways to manage how that information is organized. Because of the close relationship between the database 115 and the DBMS, as used herein, the term database 115 refers to both a database 115 and DBMS.

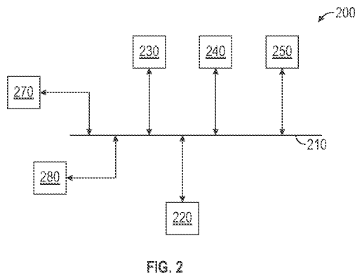

FIG. 2 is an exemplary diagram of a client 105, server 110, and/or or database 115 (hereinafter collectively referred to as “computing entity 200”), which may correspond to one or more of the clients 105, servers 110, and databases 115 according to an implementation consistent with the principles of the invention as described herein. The computing entity 200 may comprise a bus 210, a processor 220, memory 304, a storage device 250, a peripheral device 270, and a communication interface 280 (such as wired or wireless communication device). The bus 210 may be defined as one or more conductors that permit communication among the components of the computing entity 200. The processor 220 may be defined as logic circuitry that responds to and processes the basic instructions that drive the computing entity 200. Memory 304 may be defined as the integrated circuitry that stores information for immediate use in a computing entity 200. A peripheral device 270 may be defined as any hardware used by a user 405 and/or the computing entity 200 to facilitate communicate between the two. A storage device 250 may be defined as a device used to provide mass storage to a computing entity 200. A communication interface 280 may be defined as any transceiver-like device that enables the computing entity 200 to communicate with other devices and/or computing entities 200.

The bus 210 may comprise a high-speed interface 308 and/or a low-speed interface 312 that connects the various components together in a way such they may communicate with one another. A high-speed interface 308 manages bandwidth-intensive operations for computing device 300, while a low-speed interface 312 manages lower bandwidth-intensive operations. In some preferred embodiments, the high-speed interface 308 of a bus 210 may be coupled to the memory 304, display 316, and to high-speed expansion ports 310, which may accept various expansion cards such as a graphics processing unit (GPU). In other preferred embodiments, the low-speed interface 312 of a bus 210 may be coupled to a storage device 250 and low-speed expansion ports 314. The low-speed expansion ports 314 may include various communication ports, such as USB, Bluetooth, Ethernet, wireless Ethernet, etc. Additionally, the low-speed expansion ports 314 may be coupled to one or more peripheral devices 270, such as a keyboard, pointing device, scanner, and/or a networking device, wherein the low-speed expansion ports 314 facilitate the transfer of input data from the peripheral devices 270 to the processor 220 via the low-speed interface 312.

The processor 220 may comprise any type of conventional processor or microprocessor that interprets and executes computer readable instructions. The processor 220 is configured to perform the operations disclosed herein based on instructions stored within the system 400. The processor 220 may process instructions for execution within the computing entity 200, including instructions stored in memory 304 or on a storage device 250, to display graphical information for a graphical user interface (GUI) on an external peripheral device 270, such as a display 316. The processor 220 may provide for coordination of the other components of a computing entity 200, such as control of user interfaces 411, 511, 711, applications run by a computing entity 200, and wireless communication by a communication interface 280 of the computing entity 200. The processor 220 may be any processor or microprocessor suitable for executing instructions. In some embodiments, the processor 220 may have a memory device therein or coupled thereto suitable for storing the data, content, or other information or material disclosed herein. In some instances, the processor 220 may be a component of a larger computing entity 200. A computing entity 200 that may house the processor 220 therein may include, but are not limited to, laptops, desktops, workstations, personal digital assistants, servers 110, mainframes, cellular telephones, tablet computers, smart televisions, streaming devices, or any other similar device. Accordingly, the inventive subject matter disclosed herein, in full or in part, may be implemented or utilized in devices including, but are not limited to, laptops, desktops, workstations, personal digital assistants, servers 110, mainframes, cellular telephones, tablet computers, smart televisions, streaming devices, or any other similar device.

Memory 304 stores information within the computing device 300. In some preferred embodiments, memory 304 may include one or more volatile memory units. In another preferred embodiment, memory 304 may include one or more non-volatile memory units. Memory 304 may also include another form of computer-readable medium, such as a magnetic, solid state, or optical disk. For instance, a portion of a magnetic hard drive may be partitioned as a dynamic scratch space to allow for temporary storage of information that may be used by the processor 220 when faster types of memory, such as random-access memory (RAM), are in high demand. A computer-readable medium may refer to a non-transitory computer-readable memory device. A memory device may refer to storage space within a single storage device 250 or spread across multiple storage devices 250. The memory 304 may comprise main memory 230 and/or read only memory (ROM) 240. In a preferred embodiment, the main memory 230 may comprise RAM or another type of dynamic storage device 250 that stores information and instructions for execution by the processor 220. ROM 240 may comprise a conventional ROM device or another type of static storage device 250 that stores static information and instructions for use by processor 220. The storage device 250 may comprise a magnetic and/or optical recording medium and its corresponding drive.

As mentioned earlier, a peripheral device 270 is a device that facilitates communication between a user 405 and the processor 220. The peripheral device 270 may include, but is not limited to, an input device and/or an output device. As used herein, an input device may be defined as a device that allows a user 405 to input data and instructions that is then converted into a pattern of electrical signals in binary code that are comprehensible to a computing entity 200. An input device of the peripheral device 270 may include one or more conventional devices that permit a user 405 to input information into the computing entity 200, such as a controller, scanner, phone, camera, scanning device, keyboard, a mouse, a pen, voice recognition and/or biometric mechanisms, etc. As used herein, an output device may be defined as a device that translates the electronic signals received from a computing entity 200 into a form intelligible to the user 405. An output device of the peripheral device 270 may include one or more conventional devices that output information to a user 405, including a display 316, a printer, a speaker, an alarm, a projector, etc. Additionally, storage devices 250, such as CD-ROM drives, and other computing entities 200 may act as a peripheral device 270 that may act independently from the operably connected computing entity 200. For instance, a streaming device may transfer data to a smartphone, wherein the smartphone may use that data in a manner separate from the streaming device.

The storage device 250 is capable of providing the computing entity 200 mass storage. In some embodiments, the storage device 250 may comprise a computer-readable medium such as the memory 304, storage device 250, or memory 304 on the processor 220. A computer-readable medium may be defined as one or more physical or logical memory devices and/or carrier waves. Devices that may act as a computer readable medium include, but are not limited to, a hard disk device, optical disk device, tape device, flash memory or other similar solid-state memory device, or an array of devices, including devices in a storage area network or other configurations. Examples of computer-readable mediums include, but are not limited to, magnetic media such as hard disks, floppy disks, and magnetic tape; optical media such as CD ROM discs and DVDs; magneto-optical media such as optical discs; and hardware devices that are specially configured to store and perform programming instructions, such as ROM 240, RAM, flash memory, and the like.

In an embodiment, a computer program may be tangibly embodied in the storage device 250. The computer program may contain instructions that, when executed by the processor 220, performs one or more steps that comprise a method, such as those methods described herein. The instructions within a computer program may be carried to the processor 220 via the bus 210. Alternatively, the computer program may be carried to a computer-readable medium, wherein the information may then be accessed from the computer-readable medium by the processor 220 via the bus 210 as needed. In a preferred embodiment, the software instructions may be read into memory 304 from another computer-readable medium, such as data storage device 250, or from another device via the communication interface 280. Alternatively, hardwired circuitry may be used in place of or in combination with software instructions to implement processes consistent with the principles as described herein. Thus, implementations consistent with the invention as described herein are not limited to any specific combination of hardware circuitry and software.

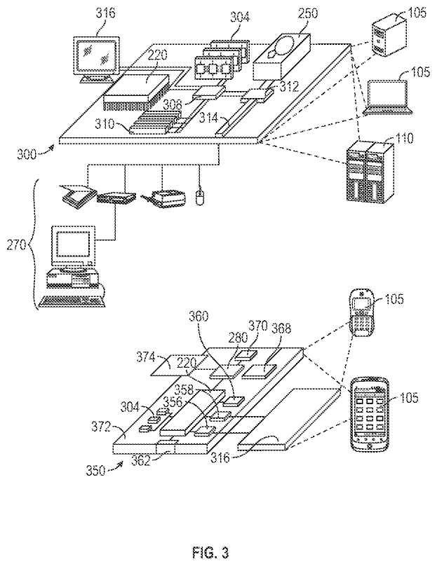

FIG. 3 depicts exemplary computing entities 200 in the form of a computing device 300 and mobile computing device 350, which may be used to carry out the various embodiments of the invention as described herein. A computing device 300 is intended to represent various forms of digital computers, such as laptops, desktops, workstations, servers 110, databases 115, mainframes, and other appropriate computers. A mobile computing device 350 is intended to represent various forms of mobile devices, such as scanners, scanning devices, personal digital assistants, cellular telephones, smart phones, tablet computers, and other similar devices. The various components depicted in FIG. 3, as well as their connections, relationships, and functions are meant to be examples only, and are not meant to limit the implementations of the invention as described herein. The computing device 300 may be implemented in a number of different forms, as shown in FIGS. 1 and 3. For instance, a computing device 300 may be implemented as a server 110 or in a group of servers 110. Computing devices 300 may also be implemented as part of a rack server system. In addition, a computing device 300 may be implemented as a personal computer, such as a desktop computer or laptop computer. Alternatively, components from a computing device 300 may be combined with other components in a mobile device, thus creating a mobile computing device 350. Each mobile computing device 350 may contain one or more computing devices 300 and mobile devices, and an entire system may be made up of multiple computing devices 300 and mobile devices communicating with each other as depicted by the mobile computing device 350 in FIG. 3. The computing entities 200 consistent with the principles of the invention as disclosed herein may perform certain receiving, communicating, generating, output providing, correlating, and storing operations as needed to perform the various methods as described in greater detail below.

In the embodiment depicted in FIG. 3, a computing device 300 may include a processor 220, memory 304 a storage device 250, high-speed expansion ports 310, low-speed expansion ports 314, and bus 210 operably connecting the processor 220, memory 304, storage device 250, high-speed expansion ports 310, and low-speed expansion ports 314. In one preferred embodiment, the bus 210 may comprise a high-speed interface 308 connecting the processor 220 to the memory 304 and high-speed expansion ports 310 as well as a low-speed interface 312 connecting to the low-speed expansion ports 314 and the storage device 250. Because each of the components are interconnected using the bus 210, they may be mounted on a common motherboard as depicted in FIG. 3 or in other manners as appropriate. The processor 220 may process instructions for execution within the computing device 300, including instructions stored in memory 304 or on the storage device 250. Processing these instructions may cause the computing device 300 to display graphical information for a GUI on an output device, such as a display 316 coupled to the high-speed interface 308. In other implementations, multiple processors and/or multiple buses may be used, as appropriate, along with multiple memory units and/or multiple types of memory. Additionally, multiple computing devices may be connected, wherein each device provides portions of the necessary operations.

A mobile computing device 350 may include a processor 220, memory 304 a peripheral device 270 (such as a display 316, a communication interface 280, and a transceiver 368, among other components). A mobile computing device 350 may also be provided with a storage device 250, such as a micro-drive or other previously mentioned storage device 250, to provide additional storage. Preferably, each of the components of the mobile computing device 350 are interconnected using a bus 210, which may allow several of the components of the mobile computing device 350 to be mounted on a common motherboard as depicted in FIG. 3 or in other manners as appropriate. In some implementations, a computer program may be tangibly embodied in an information carrier. The computer program may contain instructions that, when executed by the processor 220, perform one or more methods, such as those described herein. The information carrier is preferably a computer-readable medium, such as memory, expansion memory 374, or memory 304 on the processor 220 such as ROM 240, that may be received via the transceiver or external interface 362. The mobile computing device 350 may be implemented in a number of different forms, as shown in FIG. 3. For instance, a mobile computing device 350 may be implemented as a cellular telephone, part of a smart phone, personal digital assistant, or other similar mobile device.

The processor 220 may execute instructions within the mobile computing device 350, including instructions stored in the memory 304 and/or storage device 250. The processor 220 may be implemented as a chipset of chips that may include separate and multiple analog and/or digital processors. The processor 220 may provide for coordination of the other components of the mobile computing device 350, such as control of the user interfaces 411, 511, 711, applications run by the mobile computing device 350, and wireless communication by the mobile computing device 350. The processor 220 of the mobile computing device 350 may communicate with a user 405 through the control interface 358 coupled to a peripheral device 270 and the display interface 356 coupled to a display 316. The display 316 of the mobile computing device 350 may include, but is not limited to, Liquid Crystal Display (LCD), Light Emitting Diode (LED) display, Organic Light Emitting Diode (OLED) display, and Plasma Display Panel (PDP), holographic displays, augmented reality displays, virtual reality displays, or any combination thereof. The display interface 356 may include appropriate circuitry for causing the display 316 to present graphical and other information to a user 405. The control interface 358 may receive commands from a user 405 via a peripheral device 270 and convert the commands into a computer readable signal for the processor 220. In addition, an external interface 362 may be provided in communication with processor 220, which may enable near area communication of the mobile computing device 350 with other devices. The external interface 362 may provide for wired communications in some implementations or wireless communication in other implementations. In a preferred embodiment, multiple interfaces may be used in a single mobile computing device 350 as is depicted in FIG. 3.

Memory 304 stores information within the mobile computing device 350. Devices that may act as memory 304 for the mobile computing device 350 include, but are not limited to computer-readable media, volatile memory, and non-volatile memory. Expansion memory 374 may also be provided and connected to the mobile computing device 350 through an expansion interface 372, which may include a Single In-Line Memory Module (SIM) card interface or micro secure digital (Micro-SD) card interface. Expansion memory 374 may include, but is not limited to, various types of flash memory and non-volatile random-access memory (NVRAM). Such expansion memory 374 may provide extra storage space for the mobile computing device 350. In addition, expansion memory 374 may store computer programs or other information that may be used by the mobile computing device 350. For instance, expansion memory 374 may have instructions stored thereon that, when carried out by the processor 220, cause the mobile computing device 350 perform the methods described herein. Further, expansion memory 374 may have secure information stored thereon; therefore, expansion memory 374 may be provided as a security module for a mobile computing device 350, wherein the security module may be programmed with instructions that permit secure use of a mobile computing device 350. In addition, expansion memory 374 having secure applications and secure information stored thereon may allow a user 405 to place identifying information on the expansion memory 374 via the mobile computing device 350 in a non-hackable manner.

A mobile computing device 350 may communicate wirelessly through the communication interface 280, which may include digital signal processing circuitry where necessary. The communication interface 280 may provide for communications under various modes or protocols, including, but not limited to, Global System Mobile Communication (GSM), Short Message Services (SMS), Enterprise Messaging System (EMS), Multimedia Messaging Service (MMS), Code Division Multiple Access (CDMA), Time Division Multiple Access (TDMA), Personal Digital Cellular (PDC), Wideband Code Division Multiple Access (WCDMA), IMT Multi-Carrier (CDMAX 0), and General Packet Radio Service (GPRS), or any combination thereof. Such communication may occur, for example, through a transceiver 368. Short-range communication may occur, such as using a Bluetooth, WIFI, or other such transceiver 368. In addition, a Global Positioning System (GPS) receiver module 370 may provide additional navigation-and location-related wireless data to the mobile computing device 350, which may be used as appropriate by applications running on the mobile computing device 350. Alternatively, the mobile computing device 350 may communicate audibly using an audio codec 360, which may receive spoken information from a user 405 and covert the received spoken information into a digital form that may be processed by the processor 220. The audio codec 360 may likewise generate audible sound for a user 405, such as through a speaker, e.g., in a handset of mobile computing device 350. Such sound may include sound from voice telephone calls, recorded sound such as voice messages, music files, etc. Sound may also include sound generated by applications operating on the mobile computing device 350.

The system 400 may also comprise a power supply. The power supply may be any source of power that provides the system 400 with power. In an embodiment, the power supply may be a stationary power outlet. The system 400 may comprise of multiple power supplies that may provide power to the system 400 in different circumstances. For instance, the system 400 may be directly plugged into a stationary power outlet, which may provide power to the system 400 so long as it remains in one place. However, the system 400 may also be connected to a backup battery so that the system 400 may receive power even when the power supply is not connected to a stationary power outlet or if the stationary power outlet ceases to provide power to the computing entity 200.

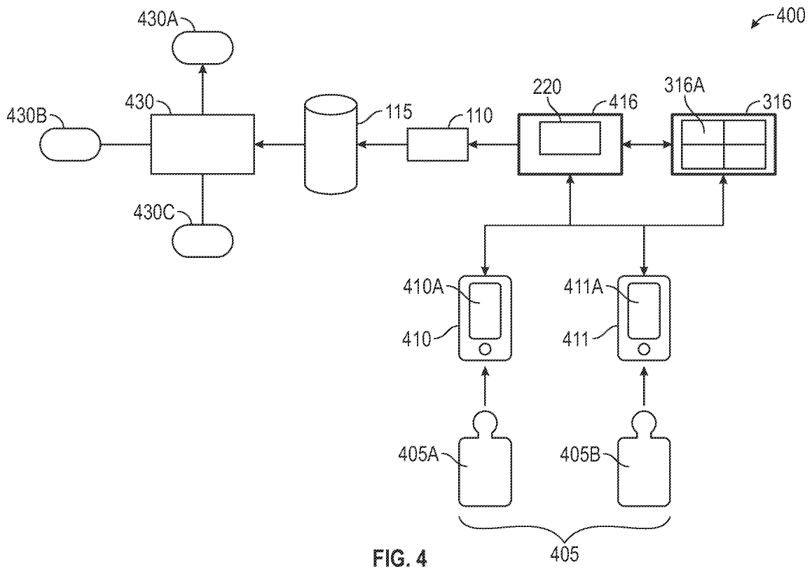

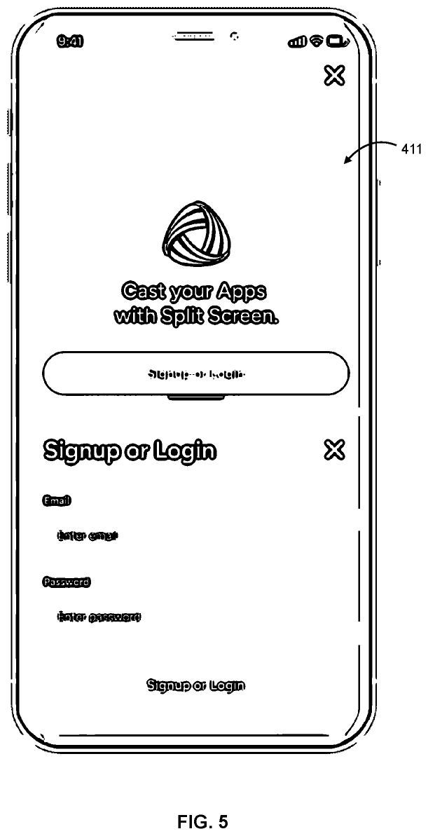

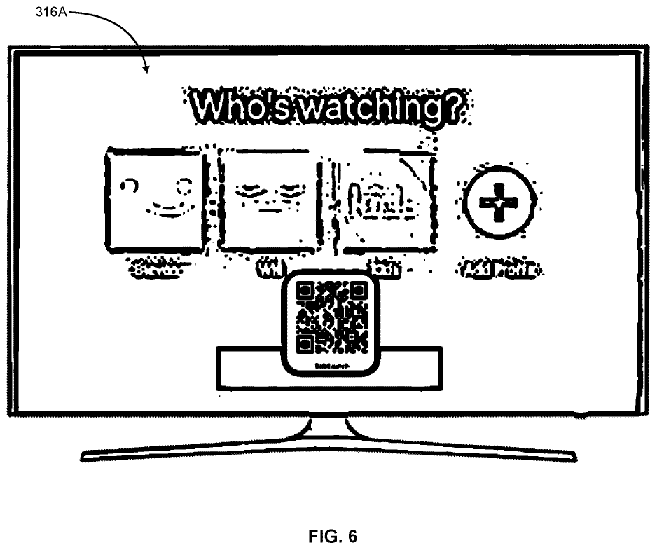

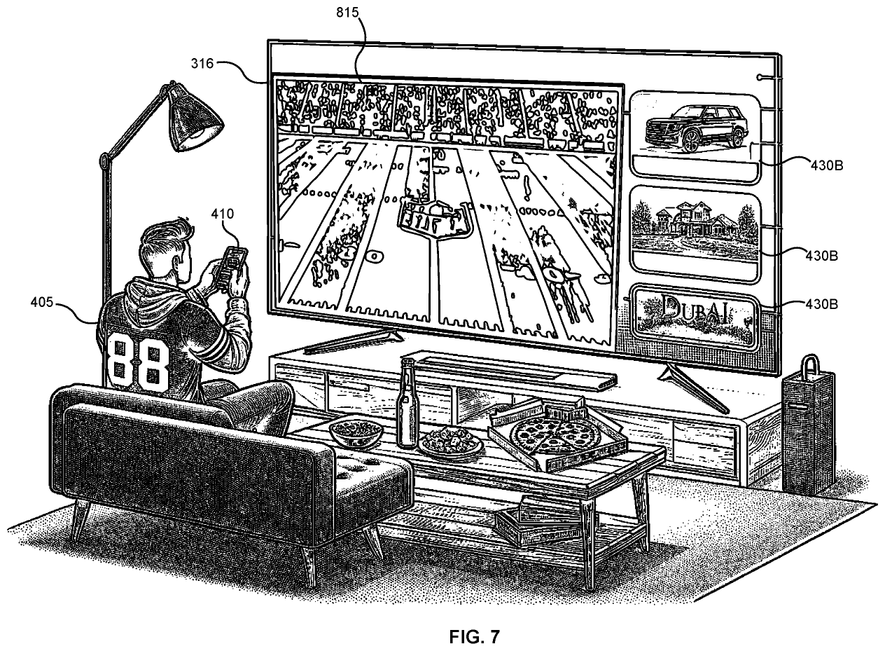

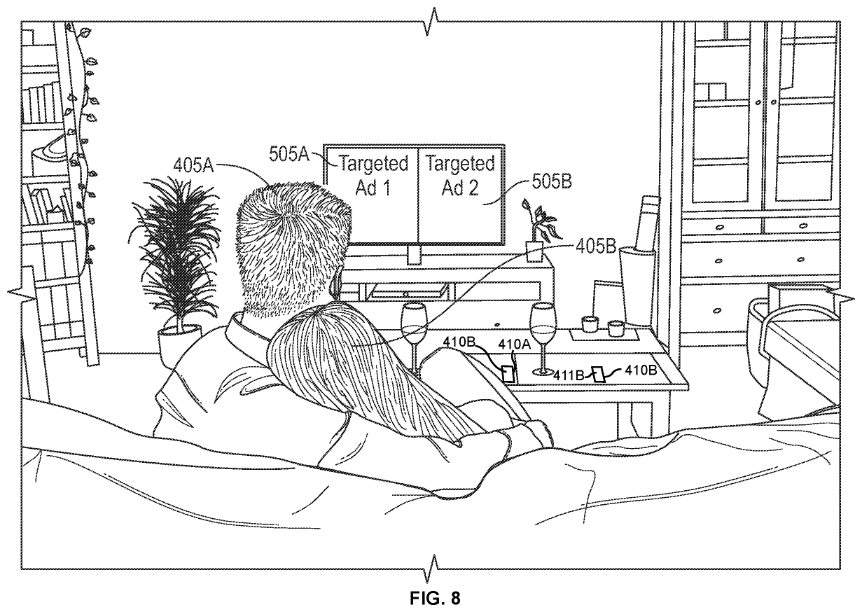

FIGS. 4-16 illustrate embodiments of a system 400 and methods for identifying users 405, securely logging into user applications based on the identity of said users 405, and creating custom advertisements based on user data 430A of said users 405 via a form of programmatic advertising. FIG. 4 illustrates a preferred embodiment of the system 400 having a computing device 410 and display 316 in fluid communication with one another. FIG. 5 illustrates an example user interface 411 of the computing device 410, wherein a display 316 operably connected to said computing device 410 may receive a computer readable signal from said computing device 410 containing login credentials. FIG. 6 illustrates an example display user interface 316A of the display 316, wherein a control board operably connected to said display 316 may receive the computer readable signal from the computing device 410. FIG. 7 is an environmental view 700 illustrating the system 400 being manipulated by a user in a homeplace. FIG. 8 is an environmental view 800 illustrating the system 400 being manipulated by a first user and a second user in a homeplace.

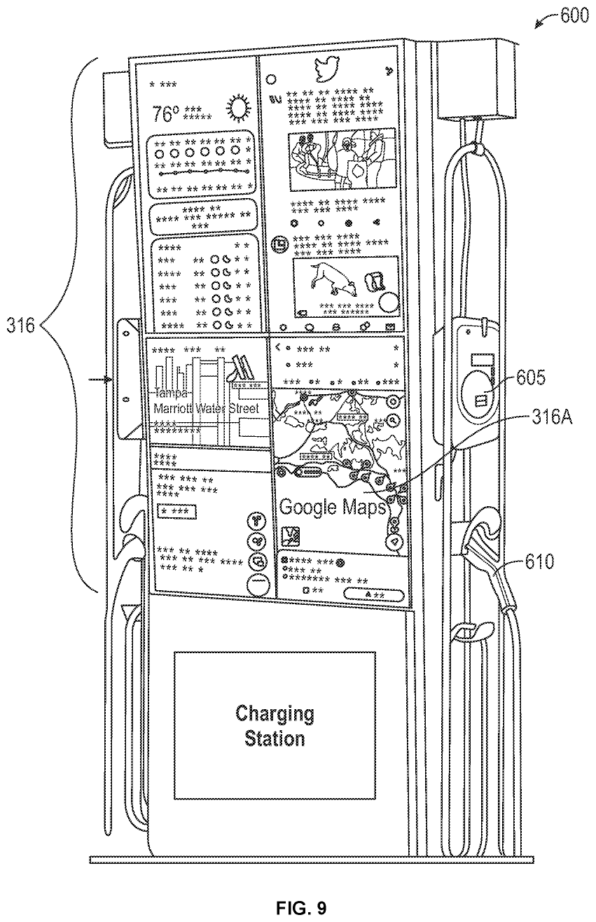

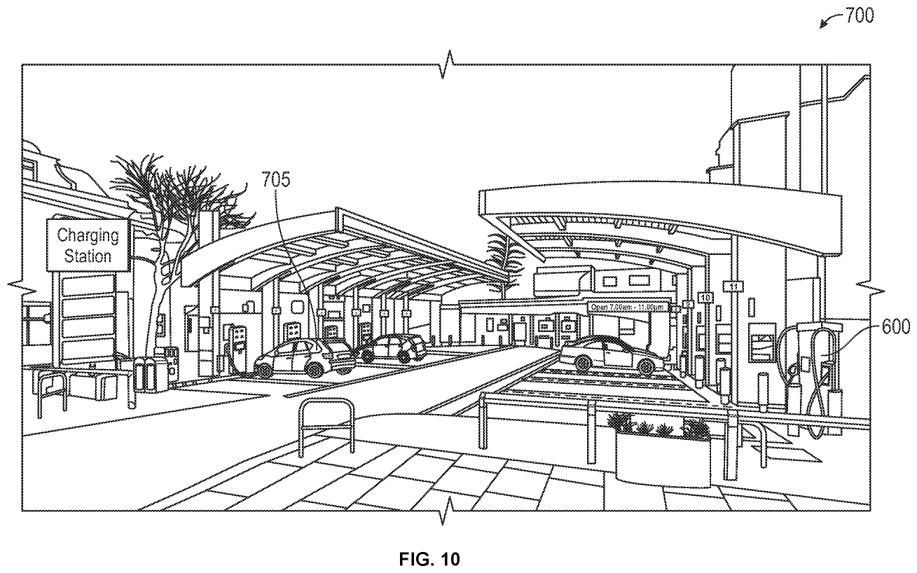

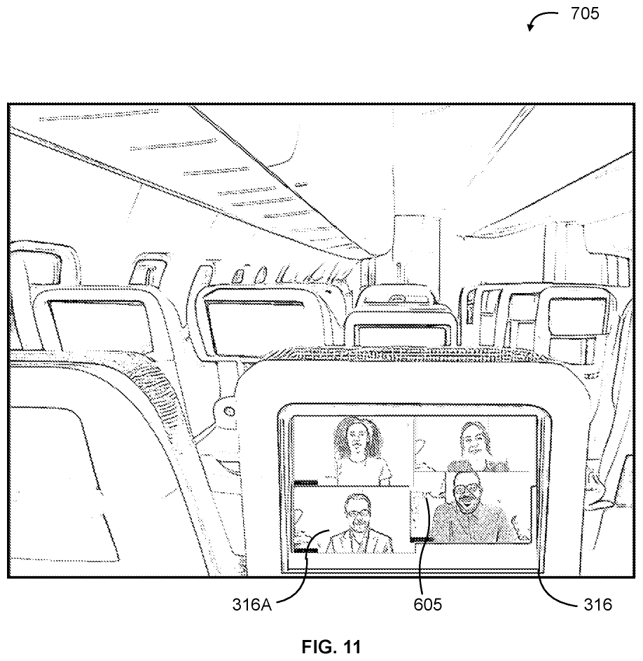

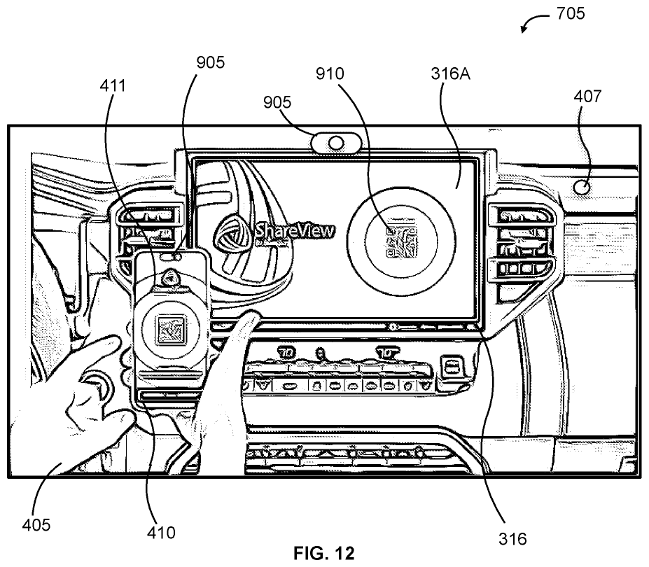

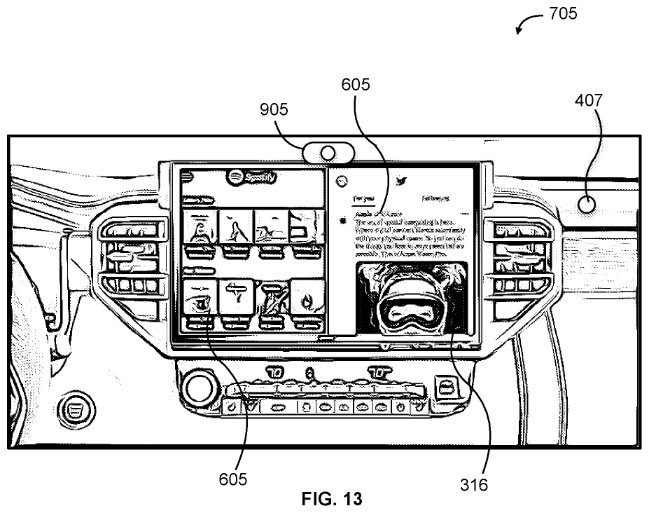

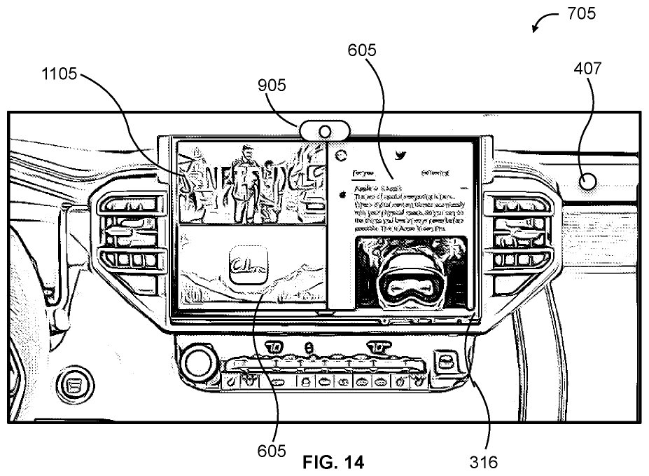

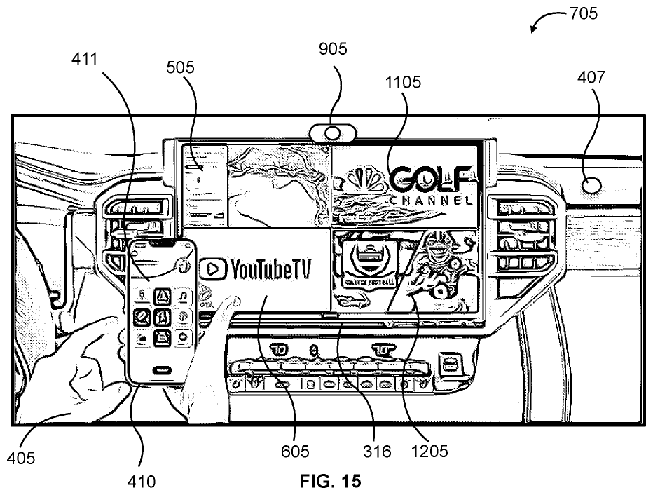

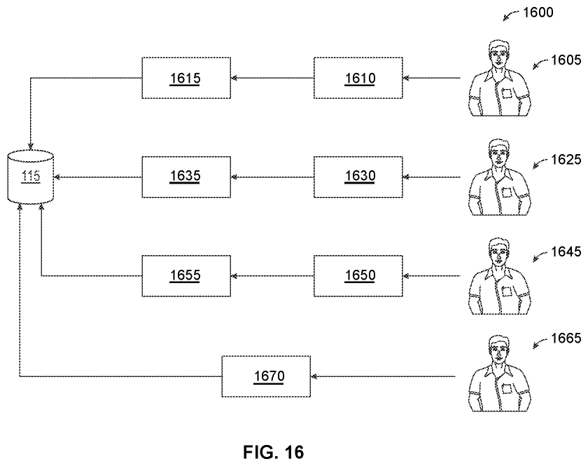

FIG. 9 is an environmental view 900 illustrating the system 400 within an environment comprising a charging station configured to charge an electric vehicle 705. FIG. 10 is an environmental view 1000 illustrating a charging area comprising a system having a plurality of charging stations configured to allow a user to manipulate a display to view content within a vehicle 705 in the form of a car. FIG. 11 is an environmental view 900 illustrating the system 400 being manipulated by a user to view content within a vehicle 705 in the form of an airplane. FIG. 12 illustrates an example user interface 411 of the system 400 being used within a vehicle 705, wherein a display 316, operably connected to a computing device 410 of a user, presents a predefined pattern 910 that may be scanned by the computing device 410 of a user 405 to grant access to the system 400. FIG. 13 illustrates an example user interface 411 of the system 400 being used within a vehicle 705, wherein two display windows of the system 400 present data to a user 405, wherein at least one of the display windows is an application window of the computing device of the user. FIG. 14 illustrates an example user interface 411 of the system 400 being used within a vehicle 705, wherein three display windows of the system 400 present data to a user, wherein at least one of the display windows is an application window of the computing device of the user. FIG. 15 illustrates an example user interface 411 of the system 400 being used within a vehicle 705, wherein four display windows of the system 400 present data to a user, wherein all four of the display windows represents an application window of the computing device of the user. FIG. 16 illustrates permission levels 1600 that may be utilized by the present system 400 for controlling access to user content such as user data 430A, advertisement data 430B, display data 430C, and image data 430D. It is understood that the various method steps associated with any methods of the present disclosure may be carried out as operations by the system 400 shown in FIGS. 4-15.

The system 400 generally comprises one or more computing devices 410 having user interfaces 411, processor 220 operably connected to said one or more computing devices 410, display 316 operably connected to said processor 220, and non-transitory computer-readable medium (CRM) 416 coupled to said processor 220 and having instructions stored thereon. Some preferred embodiments may further comprise a camera 905 operably connected to said one or more computing device 410. In one preferred embodiment, a database 115 may be operably connected to the processor 220 and the various data of the system 400 may be stored therein, including, but not limited to, user data 430A, advertisement data 430B, display data 430C, and image data 430D. In some preferred embodiments, the display 316 may further comprise a display user interface 316A (and operably connected to the first computing device 410A having a first user interface 411A and a second computing device 410B having a second user interface 411B) having a plurality of display windows configured to display 316 the various data of the system therein, wherein a control board of the display 316 is preferably configured to receive said advertisement data 430B and image data 430D and arrange said data within the display windows. In yet another preferred embodiment, a wireless communication interface may allow the processors 220 of the system 400 to receive and transmit advertisement data 430B and image data 430D therebetween.

Though some embodiments may mention a single computing device 410 of a user 405, one with skill in the art will recognize that multiple computing devices 410 of multiple users may be used without departing from the inventive subject matter described herein. Additionally, though some embodiments may refer to a single display, one with skill in the art will recognize that multiple displays may be linked together in a way that creates a “single” display that may be used in a manner not departing from the inventive subject matter described herein. For instance, four OLED televisions may be linked together in way that creates a multi-display that the system may use as a “single” display. Additionally, one with skill in the art will recognize that a plurality of displays may be controlled by a single control board, and the single control board may manage the plurality of display windows 417 about the display user interfaces of the plurality of displays. In yet another preferred embodiment, two or more control boards of two or more displays may be operably connected to one another and manage the plurality of display windows 417 about the display user interfaces of the plurality of displays in collaboration with one another. Accordingly, one with skill in the art will recognize that displays may be used in combination with one or more control boards and one or more computing devices in a number of ways without departing from the inventive subject matter described herein.

Generally, the system is designed to allow for the identification of users currently manipulating a particular display via their computing device to view content and create advertisement blocks for a user based on user data and/or display data. Users may operably connect to displays via computing devices and select data and/or applications to be presented within a display user interface of the display. In a preferred embodiment, a user may present content via a display located in their homeplace or a display not located in their homeplace, wherein the user may manipulate their computing device to control image data and applications presented within the display windows 417 of the display user interface, wherein the image data and applications may at least partially comprise application data. For instance, a user in the homeplace may use a secondary security means to associate a computing device of the user with a display within the homeplace. The user may then manipulate the user interface of the computing device in a way that causes the display to present image data and/or applications within the display windows 417 of the display user interface as chosen by the user via the user interface.

In a preferred embodiment, a control board 409 of a display 316 receives user data 430A, advertisement data 430B, display data 430C, and image data 430D from a computing entity 200. The control board 409 may then present said user data 430A, advertisement data 430B, display data 430C, and image data 430D via the display 316 in the display user interface 316A. In another preferred embodiment, the display may be configured to receive user data 430A, advertisement data 430B, display data 430C, and image data 430D via a server and/or database when selected by a user via the user interface of the computing device and/or the display user interface of the display. In a preferred embodiment, the user data 430A, advertisement data 430B, display data 430C, and image data 430D is streamed/mirrored/transmitted from the computing entity 200, server, and/or database to the control board 409, wherein the control board 409 inserts said streamed/mirrored/transmitted user data 430A, advertisement data 430B, display data 430C, and image data 430D into the display user interface 316A. In a preferred embodiment, image data is streamed/mirrored from the computing entity 200, server, and/or database to the control board 409. Alternatively, the control board 409 may manipulate the user data 430A, advertisement data 430B, display data 430C, and image data 430D and/or display windows of the display user interface 316A based on commands received from an input device.

In a preferred embodiment, a user 405 logs into a user profile of the system before accessing the various features of a display, allowing the system to verify the identity of the user. A user interface 411 of a computing device 410 allows a user to input login credentials and/or commands. A processor 220 operably connected to said computing device and said display 316 sends the login credentials and/or commands to a control board of said display via a computer readable signal, wherein said login credentials and/or commands of said computer readable signal allow access to said display should they be associated with a user profile having sufficient permission levels. A user may then manipulate the user interface of the computing device in a way that allows said user to choose various data and/or applications of the system to be presented on the display for review. In some preferred embodiments, a user 405 may be required to use a secondary security method to access a display to present the various data and/or applications of the system. For instance, a user 405 may be required to use a camera of their computing device 410 to scan a predefined pattern 910, such as a bar code or a QR code, that is presented on a display 316, which may associate that user with a particular display.

A user 405 preferably accesses the various applications of a display 316 by inputting commands within a user interface 411 of a computing device 410 operably connected to said display 316, wherein said commands cause said computing device 410 to send a computer readable signal to said display 316 containing login credentials for said various applications. In a preferred embodiment, as illustrated in FIG. 7, a user 405 may access said various applications by using a user interface 411 of a computing device 410 to login to a user profile 430 having permissions that allow said user 405 to access the various applications of the system 400, wherein said various applications are preferably subscription-based applications. After logging into their user profile 430 via the user interface 411, the user 405 may be required to use a camera of the computing device 410 to scan a predefined pattern 910, such as a bar code or a QR code, of a display 316. Once scanned and confirmed, the computing device 410 may transmit a computer readable signal to the display 316, wherein said computer readable signal may contain the user's login credentials (including the user's permission levels 1600). This may allow the user 405 to access content within the various applications based on which of said various applications that the user 405 has valid login credentials.

In one preferred embodiment, displays of the system may be configured for remote communication. Preferably, a first user uses a secondary security method to link a first computing device to a first display and a second user uses a secondary security method to link a second computing device to a second display. Once connected, the users may select the various data of the system which they would like to be presented within a display window of the displays. For instance, a first user may use a secondary security method to associate a first display within or not within the homeplace with a first computing device and first user profile. A second user may also use a secondary security method to associate a second computing device within or not within the homeplace with a second display and second user profile. The first user and second user may then manipulate the user interface in a way that allows image data of their likenesses and audio data, collected by cameras and microphones of the system, to be presented by the display via a communication window of the display user interface (imaged data) and via speakers of the display (audio data), allowing the users to see and hear one another. Additionally, a user may share data within display windows 417 of the display user interface for an enhanced communication experience. For instance, the user may choose a business contract to be displayed within the display user interface so that the first user and second user may discuss its contents. The displays are preferably operably connected to one another in a way such that data presented within the display windows 417 of each display is the same. However, though the same data may be presented within the display windows 417 of operably connected displays, the display windows 417 may or may not be organized in the same manner within the display user interfaces of the displays. In a preferred embodiment, each control board of a display controls how the content is organized within display windows 417 of the display user interface.

In some preferred embodiments, the system 400 may further comprise a secondary security device. Devices that may act as the secondary security device may include, but are not limited to, biometric devices, key cards, wearables, ignition key, or any combination thereof. In a preferred embodiment, devices that may act as the biometric devices include but are not limited to contact biometric devices, such as fingerprint scanners and hand geometry scanners, and/or non-contact biometric devices, such as face scanners, iris scanners, retina scanners, palm vein scanners, and voice identification devices. In some embodiments, the secondary security device may be operably connected to the computing device 410 and/or display 316 in a way such that it is in direct communication with the computing device 410 and/or display 316 and no other computing device 410 and/or display 316. For instance, the secondary security device in the form of a facial recognition camera may be securely and directly connected to a control board 409 of the display 316 such that a user 405 must biometrically scan their face prior to the system allowing access to the various data of the system. This may serve as way to prevent unauthorized access to data of the system 400 by a user 405 using another user's login credentials. Alternatively, the secondary security device may be used by the system 400 to prevent hijacking of the vehicle 705. In some preferred embodiments, biometric data associated with a user is saved in a user profile as user data, which the system uses to verify a user's identity. For instance, secondary security devices may be securely and directly connected to a first computing device and a second computing device in a way such that both a first user of the first computing device and a second user of the second computing device must biometrically scan thumbprints prior to the system allowing the first user and second user to access data and applications of the system in a way that allows said first user and said second user to manage vehicles remotely.

In a preferred embodiment, key cards and wearables preferably comprise a secure transmitter configured to transmit login credentials to the computing device and/or control board of the display. Wearables having a secure transmitter include clothing and accessories, such as shirts, pants, jackets, belts, shoes, wristbands, watches, glasses, pins, nametags, etc., that have said transmitter attached thereto and/or incorporated therein. The secure transmitter preferably contains login credentials in the form of a unique ID, which may be conveyed to a computing device and/or control board of a display 316 in the form of a computer readable signal. Unique IDs contained within the computer readable signal that has been broadcast by the transmitter may include, but are not limited to, unique identifier codes, social security numbers, personal identification numbers (PINs), etc. For instance, a computer readable signal broadcast by a secondary security device in the form of a background application of a computing device 410 may contain information that will alert the display 316 that a particular user 405 is within a certain range of a particular computing device 410, which may cause the system 400 to activate said particular computing device 410, which may or may not require additional steps by the user. Alternatively, the system 400 may be configured to prevent activation of a display 316, applications, and/or content if a particular user 405 is within range of the display 316. For instance, if a child having a computing device 410 broadcasting a computer readable signal containing login credentials comes within range of a display 316 having certain parental controls, the display 316 may prevent age-inappropriate content from being presented. In some embodiments, a user 405 having appropriate permission levels 1600 may override blocked content via the user interface 411 of their computing device 410 and/or by inputting an override code into said display user interface 316A.

Types of devices that may act as the transmitter include, but are not limited, to near field communication (NFC), Bluetooth, infrared (IR), radio-frequency communication (RFC), radio-frequency identification (RFID), and ANT+, or any combination thereof. In an embodiment, transmitters may broadcast signals of more than one type. For instance, a transmitter comprising an IR transmitter and RFID transmitter may broadcast IR signals and RFID signals. Alternatively, a transmitter may broadcast signals of only one type of signal. For instance, identification (ID) cards may be fitted with transmitters that broadcast NFC signals containing unique IDs associated with a particular user, wherein displays equipped with NFC receivers must receive said NFC signals containing unique IDs before access to the display user interface may be granted.

Use of secondary security devices may be used solely or in addition to secondary security methods of the system, allowing the system to have flexible multifactor identification. Simultaneous use may be beneficial to prevent unauthorized access to the various data and/or features of the system. For instance, a user may use both a secondary security method and a biometric scanner for identification purposes before allowing a user to access the various features of the system. In another preferred embodiment, the system may use a secondary security method for identification purposes and a key card or wearable for activating other features of the display, such as features that allow users to turn on/off vehicles, schedule maintenance for a vehicle, access health services, deactivate parental controls, etc. For instance, a user may use a secondary security method to allow the system to identify a user and associate a computing device of the user with a display. The user may then scan an ID card having a secure transmitter, such as a driver license, to cause the display to open a maintenance scheduler for vehicle repair. In some preferred embodiments, vehicles may transmit data pertaining to the vehicle and/or image data collected by a camera of the vehicle where it may be presented within one or more display windows 417 of a display.

In some preferred embodiments, the secondary security device may comprise a vehicle key. In a preferred embodiment, the vehicle key may further comprise a transmitter containing a unique ID, which may be transmitted to the processor 220 and/or display 316 of a vehicle 705 in the form of a computer readable signal. In one preferred embodiment, the unique ID may serve as a login credential for the system 400, allowing one to access certain features or components of the vehicle 705 only when said unique ID has been received by the processor within a set amount of time. For instance, the system 400 may be configured to prevent access to various processors of the vehicle 705 after one minute of not receiving the computer readable signal. In some preferred embodiments, a vehicle 705 may be programmed for specific users of specific vehicles. For instance, after purchasing a new vehicle, a user may be provided a custom vehicle key having a unique ID specific to the new vehicle, allowing only that vehicle key having that specific unique ID to unlock the various features of the vehicle 705, including the displays and access to the various processors of the vehicle 705. Unique IDs contained within the computer readable signal broadcast by the transmitter may include, but are not limited to, unique identifier codes, social security numbers, and PINs that may or may not further comprise an additional level of encryption. For instance, a computer readable signal broadcast by a secondary security device may contain information that will alert a processor of a particular vehicle that a particular user 405 is within a minimum threshold range, which may cause the system 400 to activate not only said vehicle 705 but also allow the user to control the various screens of a vehicle 705.

Alternatively, the secondary security device of a system 400 may be configured to prevent activation of certain features of a vehicle 705 if a particular user 405 is within the minimum threshold range. For instance, if a user possessing a vehicle key broadcasting a computer readable signal containing a unique ID comes within thirty feet of the vehicle 705 to which the vehicle key is paired, a camera 905 of the system 400 may activate and determine who is in possession of the vehicle key. If the processor determines, using image data 430D, that an authorized user of the system 400 is not present, it may prevent activation of vehicle features 505. If the processor determines that an authorized user is present, the system 400 may allow for the activation of all features of the vehicle 705. However, in some embodiments, the system 400 may only activate certain vehicle features 505 depending on the authorized user. For instance, if the system 400 determines that a child authorized user is in possession of the vehicle key and not in the company of an adult, the processor may only allow for the activation of certain vehicle features 505, including, but not limited to, air conditioning, window function. and displays of the vehicle 705. Further, the system 400 may prevent age-inappropriate content from being presented to a child in such situations in the manner discussed above. In some embodiments, a user 405 having appropriate permission levels 1600 may override certain security features of the system 400 via the user interface 411 of their computing device 410 by inputting an override code, which may cause a computer readable signal to be sent to a display that causes activation of said display 316.

In a preferred embodiment, the secondary security method may comprise a predefined pattern 910, such as a bar code or a QR code, that a user 405 must scan before the system 400 will allow said user 405 to access the various applications of the display 316. For instance, a patient in a hospital wanting to watch content provided via the display 316 may have to scan a predefined pattern 910 of a bracelet said patient was given upon admission to said healthcare treatment facility, which may then cause the display 316 to activate. For instance, a passenger on a plane wanting to access various applications of a display 316 at the airport and/or airplane may be required to scan a first predefined pattern 910 on a plane ticket using a scanning device of said passenger's computing device 410 and a second predefined pattern 910 on the display 316, which may allow the system 400 to know which user 405 is using which display 316 and what content they are allowed to view. Further, the system 400 may comprise a plurality of secondary security devices that may be used to identify users 405 of the system 400 and their permissions. For instance, the system 400 may use a combination of a biometric scanning device in addition to the methods of transmitting login credentials from a computing device 410 in the manners described herein to further prevent unauthorized access to the various applications of the display 316. Therefore, one with skill in the art will recognize that a plurality of methods may be used to prevent unwanted access to the various applications of the system 400 without departing from the inventive subject matter described herein.

In some preferred embodiments, the system 400 may capture an identifying address of any computing device 410 connected thereto. An identifying address may include, but is not limited to, basic service set identifier (BSSID), extended service set identifier (ESSID), service set identifier (SSID), and media access control (MAC) address, or any combination thereof. For instance, the system 400 may capture a MAC address of a computing device 410 wirelessly connected to the system 400 via Bluetooth. The system 400 may capture identifying addresses by actively scanning or passively scanning for computing devices 410 capable of wirelessly connecting to the system 400. In another preferred embodiment, computing devices 410 may be configured to send a computer readable signal containing said identifying address. For instance, the computing device 410 may be required to send an identifying address along with login credentials to the access computing device 410 via a computer readable signal prior to said access computing device 410 allowing a user 405 to access the various applications. This may be used to prevent multiple users 405 in different locations using a single user's login credentials. In some preferred embodiments, login credentials and the identifying address may be saved by the system 400 as log data, wherein said log data may allow the system 400 to keep a record on which users 405 access which computing devices 410 and/or displays 316 of the system 400. Other types of data that may be saved by the system 400 as log data includes, but is not limited to, login time, login date, geolocation data, image data, or any combination thereof.

In another preferred embodiment, nodes may locate a user's position within the homeplace or within the vehicle 705 relative to the various displays within said vehicle 705 and subsequently present content 1615, 1635, 1655 on the display 316 in which the system 400 has determined is most relevant to the user's location. For instance, a first user located within a back seating area of a vehicle 705 and a second user located in a front passenger area of said vehicle 705 may both be using the system 400 simultaneously on separate computing devices 410. After connecting their computing devices with the processor of the system 400 within the vehicle 705, the system 400 may determine the location of the first user and the location of the second user relative to the displays within the vehicle 705 and subsequently choose a display to present each user's chosen content 1615, 1635, 1655 based on the users'locations. For instance, the system may determine that multiple users at a bar are using their respective computing devices to watch content on one or more of the many displays within said bar. The system may use nodes to determine the location of users by triangulating their computing device and appropriately choose which screen to display content, meaning the screen most easily viewed by the user. Nodes may also allow the system 400 to more accurately choose which display to present targeted advertising due to the system 400 being able to determine which screen each user of the system 400 is most closely associated.

In some preferred embodiments, the system 400 may further comprise a camera 905 to assist with determining the location of and identifying the users of a system 400 within a homeplace or within a vehicle 705. For instance, a user may login to their user profile, connect their computing device to the system 400 in a way such that they may control one or more displays, and choose content 1615, 1635, 1655 they desire to be presented on displays of the homeplace or of the vehicle 705. A camera 905 of the system 400 may be used to determine the location of the user within the homeplace or within the vehicle 705 by using methods including, but not limited to, facial recognition, age prediction, gender prediction, or any combination thereof. The system 400 may then use this information to determine which display to present content 1615, 1635, 1655 and/or data. In yet another preferred embodiment, a user may tell the system 400 via the user interface to present content 1615, 1635, 1655 to a particular user, wherein identifying information contained within user data 430A of a user's user profile may assist the system 400 in locating the particular user within the vehicle 705. For instance, a parent may choose a child within the user interface 411 of their computing device 410 and content 1615, 1635, 1655 said child would like to view. The system 400 may then use a camera 905 to collect image data 430D in order to determine the location of the child relative to the screens within the homeplace or within the vehicle 705. Once the child and the child's location relative to the displays has been determined, the system 400 may choose which display will provide the best viewing experience for the child and then transmit the content 1615, 1635, 1655 to that display. In embodiments in which the system 400 creates and presents advertising blocks, the system 400 may use the camera 905 to modulate the targeted advertising so that it is more suitable for the age range of the users viewing content 1615, 1635, 1655.

In a preferred embodiment, the various data of the system 400 may be stored in user profiles 430. In a preferred embodiment, a user profile 430 is related to a particular user 405. A user 405 is preferably associated with a particular user profile 430 based on a username. However, it is understood that a user 405 may be associated with a user profile 430 using a variety of methods without departing from the inventive subject matter herein. Types of data that may be stored within user profiles 430 of the system 400 include, but are not limited to, user data 430A, advertisement data 430B, display data 430C, and image data 430D. One preferred embodiment of the system 400 may comprise a database 115 operably connected to the processor 220. The database 115 may be configured to store user data 430A, advertisement data 430B, display data 430C, and image data 430D within said user profiles 430. As used herein, user data 430A may be defined as personal information of a user 405 that helps the system 400 identify the user 405 and their interests. Types of data that may be used by the system 400 as user data 430A includes, but is not limited to, a user's name, username, social security number, phone number, gender, age, movie preferences, television preferences, music preferences, extracurricular preferences, food preferences, or any combination thereof. As used herein, advertisement data 430B is data related to at least one public announcement design to promote a product, brand, service, or event. Types of data that may be used by the system 400 as advertisement data 430B includes, but is not limited to, image/audio files promoting a product, brand, service, or event. As used herein, display data 430C may be defined as data that may be used to identify a particular display 316 of the system 400. Display data 430C may include, but is not limited to, geolocation data, display name, display 316 descriptions, or any combination thereof. In one preferred embodiment, the system 400 may store both user data 430A and display data 430C in user profiles 430, which may allow the system 400 to associate a particular user 405 with a particular display 316.

The database 115 may also be configured to store advertisement data 430B of the system 400, and in some preferred embodiments, the same may act as a distributor of advertisement data 430B to the display 316. Alternatively, the processor 220 and/or database 115 may transmit advertisement data 430B to a server 110, which may act as a distributor of advertisement data 430B to the display 316. In a preferred embodiment, a user profile 430 is related to a particular user 405. A user 405 is preferably associated with a particular user profile 430 based on a username or a randomly generated user ID. However, it is understood that a user 405 may be associated with a user profile 430 using a variety of methods without departing from the inventive subject matter herein. In some embodiments, the database 115 may act as a distributor of image data 430D to the control board 409 of a display 316. Alternatively, the processor 220 and/or database 115 may transmit image data 430D to a server 110, which may act as a distributor of image data 430D to the display user interface 316A of a display 316.

As previously mentioned, some preferred embodiments of the display 316 may further comprise a control board. The control board comprises at least one circuit and microchip. In another preferred embodiment, the control board may further comprise a wireless communication interface, which may allow the control board to receive instructions from an input device controlled by a user 405. In a preferred embodiment, the control board may control the plurality of display windows of the display user interface and the advertisement data 430B displayed therein. The microchip of the control board comprises a microprocessor and memory. In another preferred embodiment, the microchip may further comprise a wireless communication interface in the form of an antenna. The microprocessor may be defined as a multipurpose, clock driven, register based, digital-integrated circuit which accepts binary data as input, processes it according to instructions stored in its memory, and provides results as output. In a preferred embodiment, the microprocessor may receive advertisement data 430B from a server 110 and/or database 115 via the wireless communication interface, wherein the advertisement data 430B comprises image data in the form of a video.

As mentioned previously, the system 400 may comprise a user interface 411. A user interface 411 may be defined as a space where interactions between a user 405 and the system 400 may take place. In an embodiment, the interactions may take place in a way such that a user 405 may control the operations of the system 400. A user interface 411 may include, but is not limited to operating systems, command line user interfaces, conversational interfaces, web-based user interfaces, zooming user interfaces, touch screens, task-based user interfaces, touch user interfaces, text-based user interfaces, intelligent user interfaces, brain-computer interfaces (BCIs), and graphical user interfaces, or any combination thereof. The system 400 may present data of the user interface 411 to the user 405 via a display 316 operably connected to the processor 220. A display 316 may be defined as an output device that communicates data that may include, but is not limited to, visual, auditory, cutaneous, kinesthetic, olfactory, and gustatory, or any combination thereof.

In a preferred embodiment, the control board of the display 316 receives advertisement data 430B from the server 110 and/or database 115 and may then present said advertisement data 430B via at least one display window of the display user interface 316A, as illustrated in FIGS. 11-15. In a preferred embodiment, the advertisement data 430B is streamed from the database 115 and/or server 110 to the control board, wherein the control board inserts said streamed advertisement data 430B into said at least one display window. Alternatively, the control board may automatically select a layout of the display user interface 316A, wherein said layout may be determined based on a plurality of variables, including, but not limited to, number of users, type of content being viewed by the user(s) 405, user preferences, user location, or any combination thereof. For instance, as illustrated in FIG. 8, the control board may select a layout of a display user interface 316A comprising a split screen having two display windows configured to present two separate advertisements (a first targeted advertisement 505A and second targeted advertisement 505B) targeting two separate users (a first user 405A and a second user 405B) viewing the same content presented via an application of the display 316, wherein the users 405 were identified via user data sent by their respective computing devices (a first computing device 410A and a second computing device 410B).

Information presented via a display 316 may be referred to as a soft copy of the information because the information exists electronically and is presented for a temporary period of time. Information stored on the non-transitory computer-readable medium 416 may be referred to as the hard copy of the information. For instance, a display 316 may present a soft copy of visual information via a liquid crystal display 316 (LCD), wherein the hardcopy of the visual information is stored on a local hard drive. For instance, a display 316 may present a soft copy of audio information via a speaker, wherein the hard copy of the audio information is stored in RAM. For instance, a display 316 may present a soft copy of tactile information via a haptic suit, wherein the hard copy of the tactile information is stored within a database 115. Displays 316 may include, but are not limited to, cathode ray tube monitors, LCD monitors, light emitting diode (LED) monitors, gas plasma monitors, screen readers, speech synthesizers, haptic feedback equipment, virtual reality headsets, speakers, and scent generating devices, or any combination thereof.

In a preferred embodiment, the system 400 may comprise bundle profiles. Bundle profiles may be defined as a plurality of displays 316 that are grouped by a system 400 based on user data 430A within a user profile 430 that is associated with said plurality of displays 316. User data 430A and display data 430C may allow users 405 to control bundle profiles of the system 400 so that they may monetize their ability to advertise on the displays 316 of said bundle profile. In one preferred embodiment, a bundle profile may comprise one or more bundle profiles, wherein each bundle profile within the plurality of bundle profiles may represent at least one display 316 that may be associated with at least one particular user 405. For instance, an administrator having permissions to control which content is presented on all displays 316 within a geographic area may be associated with bundle profile that contains data on all displays 316 within said geographic area. For instance, a user 405 having permissions to control content on all displays 316 within a household may divide said household so that the displays 316 within said household are separated into multiple bundle profiles: kids and adults. In one preferred embodiment, displays 316 may be added to multiple bundle profiles. For instance, a user 405 may place a display 316 within both a local bundle profile and national bundle profile so that they may receive both local and national advertisements.

The system 400 may separate user profiles 430 into groups and subgroups (or user roles 1610, 1630, 1650). In a preferred embodiment, various groups and subgroups of the system 400 may grant permissions that give users 405 access to data and/or displays 316 within the system 400. For instance, the user profile 430 of a regional administrator may be granted permissions that allow the regional administrator to access all displays 316 within their specific region. A user profile 430 of a sub-user who owns a business in the regional administrator's specific region may be granted permissions that grant the sub-user access to displays 316 within the regional administrator's jurisdiction by placing the sub-user in a group. Therefore, a user 405 of the system 400 may change what displays 316 of the system 400 a sub-user may access by changing permissions of the sub-users.

In some preferred embodiments, bundle profiles may also be sorted into groups and subgroups, which may result in different permission levels 1600 being assigned to the bundle profiles. The permission levels 1600 may be used by the system 400 to determine which users 405 may provide advertisements to be presented via the displays 316. For instance, bundle profiles grouped in the “public” group may allow the general public to create advertisements for the displays 316 of said bundle profile. For instance, bundle profiles grouped in the “advert” group may only grant permissions to users 405 who are paying to create advertisements to be presented on the displays 316 of said bundle profile. In one preferred embodiment, bundle profiles may store display data 430C and user data 430A, which may allow the system 400 to track which users 405 are advertising on which displays 316.

The database 115 may be operably connected to the processor 220 via wired or wireless connection. In a preferred embodiment, the database 115 is configured to store u user data 430A, advertisement data 430B, display data 430C, and image data 430D within user profiles 430 and/or bundle profiles. Alternatively, the user data 430A, advertisement data 430B, display data 430C, and image data 430D stored within user profiles 430 and/or bundle profiles may be stored on the non-transitory computer-readable medium 416. The database 115 may be a relational database such that the user data 430A, advertisement data 430B, display data 430C, and image data 430D associated with each user profile 430 and bundle profile within the plurality of user profiles 430 and bundle profiles may be stored, at least in part, in one or more tables. Alternatively, the database 115 may be an object database such that u user data 430A, advertisement data 430B, display data 430C, and image data 430D associated with each user profile 430 and bundle profile of the plurality of user profiles 430 and bundle profiles may be stored, at least in part, as objects. In some instances, the database 115 may comprise a relational and/or object database and a server 110 dedicated solely to managing the user data 430A, advertisement data 430B, display data 430C, and image data 430D in the manners disclosed herein.

In one preferred embodiment, the system 400 may comprise a GPS so that the system 400 may receive geospatial data, which may be used by the system 400 to refine which advertisements are displayed to a user. For instance, a system 400 comprising a computing device having a GPS may collect geospatial data and transmit said geospatial data to the system 400. The system 400 may then use that data to determine the position of the user in relation to various businesses and subsequently present targeted advertising to a user that is specific to the user's geolocation and the businesses closest to the user. This may additionally be narrowed by data such as time of day and user data 430A to further personalize advertisements displayed to a user on screens within a homeplace or within a vehicle 705. For instance, the system 400 may be configured to present targeted advertising pertaining to food if it is between the hours of 11:00 AM and 2:00 PM and on the weekend, which may be further narrowed based on user data 430A pertaining to the user's food preferences. For instance, a system 400 comprising a computing device having a touch screen and a user interface comprising a graphic information system (GIS) that assists with directions while a user is driving may show various indicia indicating certain businesses, wherein the businesses are preferably ones in which the system 400 has determined the user frequents based on user data 430A of the system 400.

In one preferred embodiment, a user may select indicia pertaining to the location of a store presented in. targeted advertising, which may cause the system 400 to present a map showing the geolocation of the store as well as directions to the business. As such, geospatial data may be used by the system 400 in various ways by the system 400 to present targeted advertising and relay information to users thereof. As used herein, geospatial data may be spatial data including, but not limited to, numeric data, vector data, and raster data, or any combination thereof. Numeric data may be statistical data which includes a geographical component or field that can be joined with vector files so the data may be queried and displayed as a layer on a map in a GIS. Vector data may be data that has a spatial component, or X, Y coordinates assigned to it. Vector data may contain sets of points, lines, or polygons that are referenced in a geographic space. Raster data may be data in a .JPG, .TIF, .GIF or other picture file format. For instance, a map scanned in a flatbed scanner may be considered raster data.

As previously mentioned, some embodiments of the system 400 may determine the location of users 405 within a homeplace or within a particular vehicle in order to more accurately determine which user 405 is viewing which display 316. In a preferred embodiment, this may be accomplished via an indoor positioning system (IPS). The IPS may be configured to locate the user by using radio waves, magnetic fields, acoustic signals, or other sensory information that may be output by a wireless communication device of a user's computing device 410. In one embodiment, the IPS may use trilateration and triangulation methods to determine the location of a user's computing device 410 within a homeplace or within a vehicle 705 and subsequently determine what targeted advertising should be presented on which display 316. An IPS may determine the position of a user's computing device 410 using methods including, but not limited to, locator nodes 407, magnetic positioning, and dead reckoning, or any combination thereof. As described herein, locator nodes 407 are devices having positions having known locations within a homeplace or within the vehicle 705. In an embodiment, a wireless communication device may act as a locator node 407. A user's computing device 410 may be connected to the IPS in a way such that the system 400 may monitor the location of the user's computing device 410 when in range, which the system 400 may then use to estimate/confirm a user's location.

In some embodiments, the IPS may provide the processor with information that may allow the system 400 to perform additional actions based on the user's location as determined by the IPS. For instance, if the IPS of an electric car determines that a user 405 is within a minimum threshold range, the processor 220 may cause an alarm system of the electric car to be disabled. For instance, a user 405 may choose to present content 1615, 1635, 1655 within a homeplace or within a vehicle 705 and the IPS may assist the system 400 in determining which display 316 of a plurality of displays to present said content 1615, 1635, 1655 to said user 405. For instance, a plurality of users 405 may choose to present different content 1615, 1635, 1655 on displays 316 within a homeplace or within a vehicle 705 and the IPS may assist the system 400 in determining which displays 316 of the plurality of displays 316 that each user 405 of the plurality of users 405 is best positioned to view. The system 400 may also use this information to assist in determining which displays 316 that targeted advertising should be presented.

In another preferred embodiment, the vehicle key may be operably connected to the IPS system, which may allow the system 400 to take certain actions. In some preferred embodiments, should the system 400 determine that a vehicle key is not within a certain range of a locator node 407 of the IPS, the processor 220 may send a computer readable signal to various vehicular systems of the vehicle 705 that prevent said vehicular systems from functioning. For instance, should a user 405 of the system 400 in possession of a vehicle key exit the vehicle 705 with the vehicle key and walk away, the system 400 may automatically shut off the combustion engine of the vehicle 705 as soon as the vehicle key in the user's 405 possession has reached a minimum threshold distance from any of the locator nodes 407 of the vehicle 705. For instance, should a user 405 of the system 400 exit a vehicle 705 in possession of the vehicle key and the user's computing device (both operably connected to the IPS) while a child is determined to be located within the vehicle 705 by a camera 905 of the system 400, the processor may send a computer readable signal to the user's computing device to alert the user 405 as to the location of said child in the vehicle 705. In a preferred embodiment, the warning is sent to a user 405 after the vehicle key and computing device are determined to no longer be within a minimum threshold distance of the IPS. This functionality may allow the system 400 to provide content 1615, 1635, 1655 and targeted advertising to users 405 of the system 400 while simultaneously lessening the likelihood that more vulnerable users 405 of the system 400 will be placed in dangerous situations.

Some preferred embodiments of the system may further comprise application data, which may also be stored within the server and/or database. Application data may be defined as instructions that cause a display application of the display to perform an action. In one preferred embodiment, the system may determine whether a user application of the computing device is compatible with a display application of the display. If it is determined that the display application and user application are compatible, application data may be transmitted to the display from the computing device in lieu of image data. The display application is controlled by the control board of the display and inserted into a display window of the display user interface. Instructions input into a compatible user application are transmitted to the control board from the computing device and are used by the control board to perform actions of the display application, reducing the amount of data transferred between the computing device and display. For instance, a vehicle operably connected to the processor may transmit data of the vehicle to a user application version of a vehicle application of the computing device. A display application version of the vehicle application and the user application version of said vehicle application may be compatible in a way such that a user may open the user application version on their computing device and subsequently instruct the system (via the user interface) to present the user application version in a display window of the display user interface. The processor of the control board may then determine if the display application version of the vehicle application is compatible with the user application version of the vehicle application. If the display application version and user application version are compatible, the control board may open the display application version of the vehicle application locally and manipulate it via instructions received from the computing device as data of the vehicle is received or actions are taken via the user application version. If the display application version and user application version are not compatible, the control board may receive image data of the user application version of the vehicle application and present it within a display window of the display user interface. Accordingly, one with skill in the art will understand that the various data of the system may be used by the system multiple ways to carry out various functions of the system without departing from the inventive subject matter described herein.

As illustrated in FIG. 9, the system 400 may comprise a charging/fueling station 600 having a display 316, which may be used to present targeted advertising to a user 405 while they charge their electric vehicle 705. In a preferred embodiment, a charging station 600 may comprise a charging meter 605, charging plug 610, and display 316 and a fueling station may comprise a gas tank, gas pump, and a display, wherein a plurality of display windows of the display 316 may be used to present multiple pieces of targeted advertising based on user data 430A of a user 405. A charging meter 605 may be configured to obtain payment information from a user 405 and obtain user data 430A in order to display 316 targeted advertisements to the user 405. In a preferred embodiment, the charging meter 605 may also provide the user 405 with information pertaining to the charge of an electric vehicle battery/fuel cell. The charging plug 610 is configured to fit within a charging outlet of an electric vehicle 705 in order to charge a battery/fuel cell of said electric vehicle 705.

The display 316 of the charging/fueling station 600 may be used to present content 1615, 1635, 1655 and/or targeted advertising to a user 405 while the user 405 charges/fuels their vehicle 705. In a preferred embodiment, content 1615, 1635, 1655 and/or targeted advertising may be mirrored from the display 316 of the vehicle 705 to the display 316 of the charging station 600. A plurality of display windows of the display 316 of the charging station 600 may be used to present said content and/or targeted advertising. Alternatively, the charging station 600 may be configured to transmit content 1615, 1635, 1655 and/or targeted advertising to the display 316 of the vehicle 705. For instance, a charging station 600 may transmit an advertisement to the display 316 of the user's vehicle 705 while also transmitting data that indicates the charge status of the vehicle's battery to the user interface 411 of the computing device 410 of the user 405.

In a preferred embodiment, the system 400 may obtain the user's user data 430A via a wireless connection when the user 405 is within a minimum threshold range of the charging station 600. The user data 430A may be used by the charging station 600 to identify a particular user 405, which preferably occurs when payment information is provided to the charging station 600 by the user 405. This user data 430A may then be used by the system 400 to choose content 1615, 1635, 1655 and/or targeted advertising to present to the user 405 via the display 316 of the charging station. For instance, should a vehicle 705 of the system 400 come within 10 feet of a charging station of the system 400, the system 400 may obtain user data 430A of the user who owns the vehicle 705. Based on this user data 430A, the system 400 select content 1615, 1635, 1655 and targeting advertising if it is determined that content 1615, 1635, 1655 and/or targeted advertising isn't already being displayed to the used via the display of the vehicle 705. In instances that it is determined that content 1615, 1635, 1655 is already being displayed to a user, the system 400 may mirror the content 1615, 1635, 1655 and/or targeted advertising from the display of the vehicle 705 to the display of the user.

In another preferred embodiment, a user 405 may control the display of the charging station via their computing device 410 or the display 316 of their vehicle 705. The user 405 may also use their computing device 410 or the display 316 of their vehicle 705 to operably connect to the charging station 600 and activate said charging station 600 via a user interface 411 of the user's computing device 410 or the display 316 of their vehicle 705, wherein activation of the charging station 600 would cause the charging station 600 to receive the user data 430A of the user profile 430 of the user 405, allowing for the presentation of entertainment and targeted advertising to the user 405. In some preferred embodiments, the charging station 600, computing device 410, and display 316 of their vehicle 705 may be configured in a way such that charging may only be accomplished when activated through the user interface 411 or the display 316 of the vehicle 705 and only when the user interface 411 is open on the user's computing device 410 or the display 316 on in the vehicle 705 of the user 405, preventing the user 405 from avoiding targeted advertising after activation of the charging station 600. For instance, a user 405 may place the charging plug into the charging outlet of their electric vehicle 705 before moving to sit within said electric vehicle 705 while charging. Once seated within the electric vehicle 705, the user 405 may use the user interface 411 on their computing device 410 to activate the charging station 600 to charge their electric vehicle 705. So long as the user interface 411 is open on the user's computing device 410, the charging station 600 may charge the user's electric vehicle 705. In some preferred embodiments, as illustrated in FIG. 9, an energy station comprising a plurality of charging stations 600 may be used as a hub for providing targeted advertising to a plurality of users 405.

In one preferred embodiment, the system 400 may use artificial intelligence (AI) techniques to create custom advertisement blocks for users 405, wherein an advertisement block comprises at least one advertisement that is to be presented to a user 405 during a designated intermission period of streamed content. The term “artificial intelligence” and grammatical equivalents thereof are used herein to mean a method used by the system 400 to correctly interpret and learn from data of the system 400 or a plurality of systems in order to achieve specific goals and tasks through flexible adaptation. Types of AI that may be used by the system 400 include, but are not limited to, machine learning, neural network, computer vision, or any combination thereof. The system 400 preferably uses machine learning techniques to discern which advertisements a user 405 is more likely to watch based on user data 430A before creating an advertisement block for said user 405, wherein the instructions carried out by the processor 220 for said machine learning techniques are stored on the CRM 416, server 110, and/or database 115. Machine learning techniques that may be used by the system 400 include, but are not limited to, regression, classification, clustering, dimensionality reduction, ensemble, deep learning, transfer learning, reinforcement learning, or any combination thereof.

The system 400 may use more than one machine learning technique to discern which advertisements might be most interesting to a user 405 based on their user data 430A within their user profile 430. For instance, the system 400 comprising a microphone may use a combination of natural language processing and reinforcement learning to discern which advertisements that a user 405 finds more humorous and/or which products a user 405 has verbally expressed interest in. If the system 400 determines that a user 405 is showing less interest in a particular advertisement, the system 400 may create new advertisement block using advertisements the system 400 has determined the user 405 is currently showing more interest. In some preferred embodiments, the system 400 may use machine learning techniques to create advertisement blocks for a plurality of users 405 using a single display 316. For instance, if the system 400 determines that at least two users 405 have very different political interests but enjoy similar extracurricular activities, the system 400 may create an advertisement block that avoids political advertisements in favor of said extracurricular activities. For instance, if the system 400 determines that at least one user 405 is a child, the system 400 may prevent the display 316 of advertisements that might be deemed to mature for said child despite adult users being within the vicinity. The system 400 may also take into account what media content is being presented via the display 316 before creating/presenting an advertisement block. For instance, if a user 405 is watching a particular genre of movie, the system 400 may choose at least one advertisement of an advertisement block that pertains to that genre of movie.

To prevent un-authorized users from accessing other user's information, the system 400 may employ a security method. As illustrated in FIG. 16, the security method of the system 400 may comprise a plurality of permission levels 1600 that may grant users 405 access to user content 1615, 1635, 1655 within the database while simultaneously denying users 405 without appropriate permission levels 1600 the ability to view user content 1615, 1635, 1655. To access the user content 1615, 1635, 1655 stored within the database 115, users 405 may be required to make a request via a user interface 411. Access to the data within the database 115 may be granted or denied by the processor 220 based on verification of a requesting user's 1605, 1625, 1645 permission level 1600. If the requesting user's 1605, 1625, 1645 permission level 1600 is sufficient, the processor 220 may provide the requesting user 1605, 1625, 1645 access to user content 1615, 1635, 1655 stored within the database. Conversely, if the requesting user's 1605, 1625, 1645 permission level 1600 is insufficient, the processor 220 may deny the requesting user 1605, 1625, 1645 access to user content 1615, 1635, 1655 stored within the database. In an embodiment, permission levels 1600 may be based on user roles 1610, 1630, 1650 and administrator roles 1670, as illustrated in FIG. 16. User roles 1610, 1630, 1650 allow requesting users 1605, 1625, 1645 to access user content 1615, 1635, 1655 that a user 405 has uploaded and/or otherwise obtained through use of the system 400. Administrator roles 1670 allow administrators 1665 to access system 400 wide data.

In an embodiment, user roles 1610, 1630, 1650 may be assigned to a user 405 in a way such that a requesting user 1605, 1625, 1645 may view user profiles 430 containing user data 430A, advertisement data 430B, display data 430C, and image data 430D via a user interface 411. To access the data within the database 115, a user 405 may make a user request via the user interface 411 to the processor 220. In an embodiment, the processor 220 may grant or deny the request based on the permission level 1600 associated with the requesting user 1605, 1625, 1645. Only users 405 having appropriate user roles 1610, 1630, 1650 or administrator roles 1670 may access the data within the user profiles 430. For instance, as illustrated in FIG. 16, requesting user 1 1605 has permission to view user 1 content 1615 and user 2 content 1635 whereas requesting user 2 1625 only has permission to view user 2 content 1635. Alternatively, user content 1615, 1635, 1655 may be restricted in a way such that a user may only view a limited amount of user content 1615, 1635, 1655. For instance, requesting user 3 1645 may be granted a permission level 1600 that only allows them to view user 3 content 1655 related to their specific interest but not user 3 content 1655 related to the identity of said user 405. In the example illustrated in FIG. 16, an administrator 1665 may bestow a new permission level 1600 on users 405 so that it may grant them greater permissions or lesser permissions. For instance, an administrator 1665 may bestow a greater permission level 1600 on other users 405 so that they may view user 3's content 1655 and/or any other user's content 1615, 1635, 1655. Therefore, the permission levels 1600 of the system 400 may be assigned to users 405 in various ways without departing from the inventive subject matter described herein.

The subject matter described herein may be embodied in systems, apparati, methods, and/or articles depending on the desired configuration. In particular, various implementations of the subject matter described herein may be realized in digital electronic circuitry, integrated circuitry, specially designed application specific integrated circuits (ASICs), computer hardware, firmware, software, and/or combinations thereof. These various implementations may include implementation in one or more computer programs that may be executable and/or interpretable on a programmable system including at least one programmable processor, which may be special or general purpose, coupled to receive data and instructions from, and to transmit data and instructions to, a storage system, and at least one peripheral device.

These computer programs, which may also be referred to as programs, software, applications, software applications, components, or code, may include machine instructions for a programmable processor, and may be implemented in a high-level procedural and/or object-oriented programming language, and/or in assembly machine language. As used herein, the term “non-transitory computer-readable medium” refers to any computer program, product, apparatus, and/or device, such as magnetic discs, optical disks, memory, and Programmable Logic Devices (PLDs), used to provide machine instructions and/or data to a programmable processor, including a non-transitory computer-readable medium that receives machine instructions as a computer-readable signal. The term “computer-readable signal” refers to any signal used to provide machine instructions and/or data to a programmable processor. To provide for interaction with a user, the subject matter described herein may be implemented on a computer having a display device, such as a cathode ray tube (CRD), liquid crystal display (LCD), light emitting display (LED) monitor for displaying information to the user and a keyboard and a pointing device, such as a mouse or a trackball, by which the user may provide input to the computer. Displays may include, but are not limited to, visual, auditory, cutaneous, kinesthetic, olfactory, and gustatory displays, or any combination thereof.

Other kinds of devices may be used to facilitate interaction with a user as well. For instance, feedback provided to the user may be any form of sensory feedback, such as visual feedback, auditory feedback, or tactile feedback; and input from the user may be received in any form including, but not limited to, acoustic, speech, or tactile input. The subject matter described herein may be implemented in a computing system that includes a back-end component, such as a data server, or that includes a middleware component, such as an application server, or that includes a front-end component, such as a client computer having a graphical user interface or a Web browser through which a user may interact with the system described herein, or any combination of such back-end, middleware, or front-end components. The components of the system may be interconnected by any form or medium of digital data communication, such as a communication network. Examples of communication networks may include, but are not limited to, a local area network (“LAN”), a wide area network (“WAN”), metropolitan area networks (“MAN”), and the internet.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For instance, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, devices, and arrangements of the parts and method stages which have been described and illustrated in order to explain the nature of this inventive subject matter can be made without departing from the principles and scope of the inventive subject matter.

What is claimed is:

1. A system for identifying a user and presenting targeted advertisements comprising:
a first computing device having a first user interface,
wherein said first user interface of said first computing device allows a first user to choose a first content,
wherein said first computing device sends first user data to at least one of a server and a database when said first user selects said first content,
a second computing device having a second user interface,
wherein said second user interface of said second computing device allows a second user to choose a second content,
wherein said second computing device sends second user data to at least one of said server and said database when said second user selects said second content,
a display operably connected to said first computing device and said second computing device,
wherein a control board of said display is configured to receive said first user data and said second user data from said first computing device and said second computing device,
wherein said first user data and said second user data received by said control board of said display allows said control board to identify said first user and said second user,
wherein said control board of said display is configured to receive said first content chosen by said first user and said second content chosen by said second user,
wherein said control board of said display organizes said first content and said second content in a plurality of display windows of a display user interface of said display,
wherein said control board is configured to receive first advertisement data and second advertisement data from at least one of said server and said database,
wherein said control board of said display organizes said first advertisement data and said second advertisement data in said plurality of display windows of said display user interface of said display,
a processor operably connected to said first computing device, second computing device, server, and display,
a non-transitory computer-readable medium coupled to said processor,
wherein said non-transitory computer-readable medium contains instructions stored thereon, which, when executed by said processor, cause said processor to perform operations comprising:
receiving first user data from said first computing device and said second user data from said second computing device,
receiving said first content and said second content chosen via said first user interface and said second user interface,
receiving, from at least one of said server and said database, said first advertisement data for said first user and said second advertisement data for said second user,
wherein said first advertisement data to be presented to said first user is determined based on said first user data
wherein said second advertisement data to be presented to said second user is determined based on said second user data,
receiving, from at least one of said server and said database, said second advertisement data for said second user,
presenting said first content and said second content within said plurality of display windows of said display user interface,
presenting said first advertisement data for said first user and said second advertisement data for said second user within said plurality of display windows of said display user interface.

2. The system of claim 1, further comprising display data associated with said display,
wherein said display data is used in conjunction with said first user data to determine said first advertisement data for said first user,
wherein said display data is used in conjunction with said second user data to determine said second advertisement data for said second user.

3. The system of claim 2, wherein said display data contains geospatial data pertaining to a geolocation of said display, wherein said first advertisement data and said second advertisement data contains a geospatial tag, wherein said geospatial tag prevents a determination of advertisement data for said first user and said advertisement data for said second user if said advertisement data does not have a geospatial tag that matches said geospatial data.

4. The system of claim 1, further comprising additional instructions stored on said non-transitory computer-readable medium, which, when executed by said processor, cause said processor to perform additional operations comprising:
determining a layout of said plurality of display windows of said display user interface based on user data and advertisement data.

5. The system of claim 4, further comprising a secondary security device operably connected to said control board and configured to communicate with said control board of said display.

6. The system of claim 5, wherein said secondary security device is configured to collect at least one of biometric data, image data, and log data from at least one of said first user or said second user, wherein said biometric data, image data, and log data is used by said control board to identify at least one of said first user or said second user, wherein identification of at least one of said first user or said second user causes said system to activate applications of said display.

7. The system of claim 6, further comprising additional instructions stored on said non-transitory computer-readable medium, which, when executed by said processor, cause said processor to perform additional operations comprising:
receiving at least one of said biometric data, image data, and log data from said secondary security device,
checking at least one of said biometric data, image data, and log data against login credentials,
activating said applications of said display when at least one of said biometric data, image data, and log data matches said login credentials.

8. The system of claim 7, wherein said secondary security device is configured to send a computer readable signal to said control board, wherein said computer readable signal is used by said control board to verify login credentials of said user, wherein said login credentials allow said user to access applications of said display.

9. The system of claim 8, further comprising additional instructions stored on said non-transitory computer-readable medium, which, when executed by said processor, cause said processor to perform additional operations comprising:
receiving a computer readable signal from said secondary security device,
checking said computer readable signal against said login credentials,
activating said applications of said display when said computer readable signal matches said login credentials.

10. The system of claim 1, further comprising an input device operably connected to said first computing device and said second computing device,
wherein said input device is at least one of a camera and microphone connected to at least one of said first computing device and second computing device,
wherein said camera is configured to collect image data of said user,
wherein said microphone is configured to collect audio data of said user.

11. The system of claim 10, wherein machine learning is used to locate a position of said user relative said display, wherein machine learning is used to transform said audio data into input data, wherein said control board manipulates a layout based on at least one of said position and said input data.

12. The system of claim 11, wherein said control board determines a window number of said display user interface, wherein said window number is equal to a total number of viewers that are determined to be within range of said display, wherein said control board manipulates said layout based on said total number of viewers, wherein said window number determines an amount of said plurality of display windows.

13. The system of claim 1, further comprising a charging station having a charging meter,
wherein said charging meter is configured to collect user data from at least one of said user or said second user,
wherein said user data is used by said charging station to determine at least one of targeted entertainment and targeted advertising for at least one of said first user or said second user,
wherein said charging station presents at least one of said targeted entertainment and targeted advertising on said display of said charging station.

14. The system of claim 13, wherein at least one of said first computing device or said second computing device is operably connected to said charging station,
wherein said charging station only charges an electric vehicle when at least one of said first computing device or second computing device is within a certain range of said charging station.

15. The system of claim 13, wherein at least one of said first computing device or said second computing device is operably connected to said charging station,
wherein said charging station is activated by an application of at least one of said first computing device or said second computing device,
wherein said charging station only charges an electric vehicle when said application is open on at least one of said first computing device or said second computing device.

16. A system for controlling displays within a vehicle, comprising:
at least one display within a vehicle,
wherein said at least one display comprises a control board having a processor and configured to receive image data,
wherein said control board presents said image data in a plurality of display windows of a display user interface of said at least one display,
wherein said plurality of display windows splits a viewing area of said at least one display into at least two regions,
a computing device operably connected to said processor and having a user interface,
wherein said user interface allows a user to choose content to present on said at least one display,
wherein said computing device is configured to transmit image data to said control board,
a non-transitory computer-readable medium coupled to said processor,
wherein said non-transitory computer-readable medium contains instructions stored thereon, which, when executed by said processor, cause said processor to perform operations comprising:
receiving said content from said computing device as chosen by said user,
determining a layout of said display user interface based on said content, and
presenting said layout containing said content via said at least one display.

17. The system of claim 16, further comprising a camera configured to collect image data in a way that allows said processor to determine a location of said user within said vehicle.

18. The system of claim 17, further comprising additional instructions stored on said non-transitory computer-readable medium, which, when executed by said processor, cause said processor to perform additional operations comprising:
receiving said image data from said camera,
determining said location of said user within said vehicle using said image data, and
selecting a specific display of said at least one display based on said location of said user,
wherein said specific display is said at least one display determined to be closest to said user.

19. The system of claim 16, wherein said control board is configured to receive user data from said computing device,
wherein said processor of said control board is configured to receive advertisement data based on said user data,
wherein said processor of said control board organizes said advertisement data in said plurality of display windows of said display user interface of said at least one display.

20. The system of claim 19, further comprising a communication interface operably connected to said control board,
wherein an input device transmits commands to said control board via said communication interface,
wherein said commands instruct said processor as to a layout of said display user interface based on said user data and said advertisement data.

21. The system of claim 20, further comprising additional instructions stored on said non-transitory computer-readable medium, which, when executed by said processor, cause said processor to perform additional operations comprising:
receiving said advertisement data,
determining said layout of said display user interface based on user data and advertisement data, and
presenting said advertisement data within said display user interface based on said layout.

22. The system of claim 21, further comprising a secondary security device operably connected to said control board and configured to communicate with said control board of said at least one display.

23. The system of claim 22, wherein said secondary security device is configured to collect at least one of biometric data, image data, and log data from said user, wherein said biometric data, image data, and log data is used by said control board to identify said user, wherein identification of said user causes said system to activate applications of said at least one display.

24. The system of claim 23, further comprising additional instructions stored on said non-transitory computer-readable medium, which, when executed by said processor, cause said processor to perform additional operations comprising:
receiving at least one of said biometric data, image data, and log data from said secondary security device,
checking at least one of said biometric data, image data, and log data against login credentials, and
activating vehicle features when at least one of said biometric data, image data, and log data matches said login credentials.

25. The system of claim 24, wherein said secondary security device is configured to send a computer readable signal to said control board, wherein said computer readable signal is used by said processor to activate said vehicle features.

26. The system of claim 25, further comprising additional instructions stored on said non-transitory computer-readable medium, which, when executed by said processor, cause said processor to perform additional operations comprising:
receiving said computer readable signal from said secondary security device,
checking said computer readable signal against a unique ID,
activating said vehicle features of said vehicle when said computer readable signal matches said unique ID.

27. The system of claim 16, further comprising a locator node operably connected to said processor and said computing device,
wherein said locator node has a known position within said vehicle,
wherein said locator node transmits a computing device position to said processor,
wherein said computing device transmits a position signal to said locator node and said processor.

28. The system of claim 27, further comprising additional instructions stored on said non-transitory computer-readable medium, which, when executed by said processor, cause said processor to perform additional operations comprising:
receiving said position signal transmitted by said computing device,
receiving said computing device position from said locator node,
determining a location of said user via triangulation using said position signal and said locator node, and
selecting a specific display of said at least one display based on said location of said user,
wherein said specific display is said at least one display determined to be closest to said user.

29. A system for controlling displays within a vehicle, comprising:
at least one display within a vehicle,
wherein said at least one display comprises a control board having a processor and configured to receive image data,
wherein said control board presents said image data in a plurality of display windows of a display user interface of said at least one display,
wherein said plurality of display windows splits a viewing area of said at least one display into at least two regions, a mobile computing device operably connected to said processor and having a user interface,
wherein said user interface allows a user to choose content to present on said at least one display,
wherein said mobile computing device is configured to transmit image data to said control board, a locator node operably connected to said processor and said mobile computing device,
wherein said locator node has a known position within said vehicle,
wherein said locator node transmits a mobile computing device position to said processor,
wherein said mobile computing device transmits a position signal to said locator node and said processor,
a non-transitory computer-readable medium coupled to said processor,
wherein said non-transitory computer-readable medium contains instructions stored thereon, which, when executed by said processor, cause said processor to perform operations comprising:
receiving said content from said mobile computing device as chosen by said user via said user interface,
receiving said position signal transmitted by said mobile computing device,
receiving said mobile computing device position from said locator node,
determining a location of said user via triangulation using said position signal and said locator node,
selecting a specific display of said at least one display based on said location of said user, and
presenting said content within a plurality of windows of said display user interface of said specific display.

30. The system of claim 29, further comprising a camera configured to collect image data in a way that allows said processor to determine said location of said user within said vehicle.

31. The system of claim 30, further comprising additional instructions stored on said non-transitory computer-readable medium, which, when executed by said processor, cause said processor to perform additional operations comprising:
receiving said image data from said camera,
checking said location of said user as determined by said triangulation against said image data, and
selecting a specific display of said at least one display based on said location of said user when said location as determined by said image data and said location as determined by a triangulation match.

32. The system of claim 29, further comprising a secondary security device operably connected to said processor, wherein said secondary security device is configured to send a computer readable signal to said control board, wherein said computer readable signal is used by said processor to activate vehicle features.

33. The system of claim 32, wherein said secondary security device is configured to collect at least one of biometric data, image data, and log data from said user, wherein said biometric data, image data, and log data is used by said control board to identify said user, wherein identification of said user causes said system to activate said vehicle features.

34. A system for controlling displays within a vehicle, comprising:
at least one display within a vehicle,
wherein said at least one display comprises a control board having a processor and configured to receive image data,
wherein said control board presents said image data in a plurality of display windows of a display user interface of said at least one display,
wherein said plurality of display windows splits a viewing area of said at least one display into at least two regions,
a camera configured to collect image data in a way that allows said processor to determine a location of a user within said vehicle,
a secondary security device operably connected to said processor,
wherein said secondary security device is configured to send a computer readable signal to said control board,
wherein said computer readable signal is used by said processor to activate said at least one display,
a mobile computing device operably connected to said processor and having a user interface,
wherein said user interface allows a user to choose content to present on said at least one display,
wherein said mobile computing device is configured to transmit image data to said control board,
a non-transitory computer-readable medium coupled to said processor,
wherein said non-transitory computer-readable medium contains instructions stored thereon, which, when executed by said processor, cause said processor to perform operations comprising:
receiving said content from said mobile computing device as chosen by said user,
receiving said image data from said camera,
receiving said computer readable signal from said secondary security device,
activating said at least one display when said computer readable signal matches a unique ID of said vehicle,
determining said location of said user within said vehicle using said image data,
selecting a specific display of said at least one display based on said location of said user, and
presenting said content via said specific display within said plurality of display windows.

35. The system of claim 34, wherein said control board is configured to receive user data from said mobile computing device,
wherein said processor of said control board is configured to receive advertisement data based on said user data,
wherein said processor of said control board organizes said advertisement data in said plurality of display windows of said display user interface of said specific display.
